(19) United States
(12) Patent Application Publication
(10) Pub. No.: US 2012/0312078 A1
(43) Pub. Date: Dec. 13, 2012

(54) PIPELINE REFLECTOMETRY APPARATUSES AND METHODS

(76) Inventor: Mehrdad Sharif Bakhtiar, Toronto (CA)

(21) Appl. No.: 13/156,403

(22) Filed: Jun. 9, 2011

(51) Int. Cl. G01M 3/24; G01N 29/14; G01N 29/04

(52) U.S. Cl. 73/40.5 A; 73/592; 73/587

(57) ABSTRACT

A stationary apparatus connected to a pipeline can include an acoustic signal transmitter configured to transmit acoustic signals periodically into the pipeline. A mobile apparatus inserted into the pipeline can include at least one sensor unit configured to measure conditions surrounding the mobile apparatus as the mobile apparatus travels inside the pipeline, and an acoustic signal receiver unit. A controller can be configured to associate the acoustic signals received by the mobile apparatus with the conditions being measured, and store data in a memory device. Each of the acoustic signals can include an identifier code that is representative of transmission time at the stationary apparatus, and the controller can be configured to associate the identifier code with the conditions being measured by the mobile apparatus.

### FIELD

This specification relates to reflectometry, and oil and gas pipeline technology.

### BACKGROUND

The following paragraphs are not an admission that anything discussed in them is prior art or part of the knowledge of persons skilled in the art.

U.S. Pat. No. 5,027,644 describes a method and apparatus for generating and introducing an acoustic signal into a piping system, such as a natural gas distribution system. A first case is sealably secured to a second case to form a diaphragm case. A diaphragm is sealably positioned within the diaphragm case between the first case and the second case. The first case and the diaphragm define a first chamber and the second case and the diaphragm define a second chamber. The first chamber is preferably in communication with the ambient atmosphere and operates at atmospheric pressure. The diaphragm case is one component of a pressure regulator that has an inlet and an outlet for connecting the pressure regulator within a piping system. The pressure regulator regulates fluid pressure within the piping system, downstream from the pressure regulator. The pressure regulator has a valve plug and a valve stem connected to the valve plug. An opposite end of the valve stem is connected to the diaphragm. An acoustic signal is introduced into the first chamber in order to vibrate the diaphragm and produce an acoustic signal, preferably amplified, within the piping system, downstream from the pressure regulator.

U.S. Pat. No. 6,751,560 describes a system and method for non-invasive pipeline inspection. According to one embodiment, the system includes a processor, an analyzer, and a wave launcher. The wave launcher is adapted to transmit an input wideband waveform having a selected input energy into the pipeline along a longitudinal axis, and to receive from the pipeline a reflected component of the input waveform having a reflected energy. The analyzer is adapted to generate the input waveform, and to receive the reflected component of the input waveform from the wave launcher. The processor is adapted to compare the input waveform with the reflected component of the input waveform to determine characteristics.

U.S. Pat. No. 6,931,952 describes a device called “pill” provided for in-line measurement of properties, such as pressure and temperature, in a fluid flow within a pipeline system. The device is small enough to travel in the medium of the pipeline system in an unrestricted manner. It has at least one sensor to scan properties such as pressure and temperature at a desired rate. Also, the device includes a microprocessor for logging data scanned by the sensor so that it can later be downloaded and analysed by a PC. Moreover, the device has a buoyancy compensator for adjusting the specific gravity of the device to make it compatible with the medium in which it travels. The novel device is particularly suitable for use in solids transport systems, such as mining backfill systems.

### INTRODUCTION

In an aspect of this specification, a stationary apparatus for connection to a pipeline can comprise an acoustic signal transmitter configured to transmit acoustic signals periodically into the pipeline, and a controller coupled to the acoustic signal transmitter. A mobile apparatus for insertion into the pipeline can comprise at least one sensor unit configured to measure conditions surrounding the mobile apparatus as the mobile apparatus travels inside the pipeline, an acoustic signal receiver unit configured to receive the acoustic signals from the stationary apparatus, a memory device, and a controller coupled to the at least one sensor unit, the acoustic signal receiver unit, and the memory device. The controller can be configured to associate the acoustic signals with the conditions being measured by the at least one sensor unit based on a reception time of the acoustic signal and the conditions being measured generally at the reception time, and store data in the memory device pertaining to the acoustic signals and the conditions.

In another aspect of this specification, a method of detecting a leak in a pipeline can comprise: providing a stationary apparatus, and connecting the stationary apparatus to the pipeline; transmitting acoustic signals periodically from the stationary apparatus into the pipeline; providing a mobile apparatus, and inserting the mobile apparatus into the pipeline such that the mobile apparatus travels inside the pipeline; measuring conditions surrounding the mobile apparatus as the mobile apparatus travels inside the pipeline, the conditions indicating the presence of the leak when the mobile apparatus is in the vicinity of the leak; receiving at the mobile apparatus the acoustic signals transmitted from the stationary apparatus; and associating each of the acoustic signals received at the mobile apparatus with the conditions being measured by the mobile apparatus based on a reception time of the acoustic signal and the conditions being measured generally at the reception time.

In another aspect of this specification, a mobile apparatus for insertion into a pipeline can comprise: at least one sensor unit configured to measure conditions surrounding the mobile apparatus as the mobile apparatus travels inside the pipeline; an acoustic signal receiver unit configured to receive acoustic signals that are transmitted periodically inside the pipeline, wherein the acoustic signals have a predetermined period; a memory device; and a controller coupled to the at least one sensor unit, the acoustic signal receiver unit, and the memory device, and configured to calculate a current location of the mobile apparatus based on a reception time of a currently received acoustic signal, a reception time of a previously received acoustic signal, a previous location of the mobile apparatus when the previously received acoustic signal was received, the period of the acoustic signals, and a velocity of the acoustic signals inside the pipeline, associate the current location with the conditions being measured by the at least one sensor unit, and store data in the memory device pertaining to the location and the conditions.

In another aspect of this specification, a method of detecting a leak in a pipeline can comprise: providing a mobile apparatus, and inserting the mobile apparatus into the pipeline such that the mobile apparatus travels inside the pipeline; measuring conditions surrounding the mobile apparatus as the mobile apparatus travels inside the pipeline, the conditions indicating the presence of the leak when the mobile apparatus is in the vicinity of the leak; receiving at the mobile apparatus acoustic signals that are transmitted periodically inside the pipeline, wherein the acoustic signals have a predetermined period; calculating a current location of the mobile apparatus based on a reception time of a currently received acoustic signal, a reception time of a previously received acoustic signal, a previous location of the mobile apparatus when the previously received acoustic signal was received, the period of the acoustic signals, and a velocity of the acoustic signals inside the pipeline; and associating the current location with the conditions being measured by the at least one sensor unit.

In another aspect of this specification, a stationary apparatus for connection to a pipeline can comprise: an acoustic signal transmitter configured to transmit acoustic signals into the pipeline; an acoustic signal receiver unit, configured to receive reflected acoustic signals inside the pipeline; a memory device; and a controller coupled to the acoustic signal transmitter, the acoustic signal receiver unit, and the memory device, and configured to encode an identifier code in each of the acoustic signals that is representative of a transmission time of the respective acoustic signal, and store data in the memory device pertaining to the reflected acoustic signals and the identifier codes.

In yet another aspect of this specification, a method of detecting an obstacle in a pipeline can comprise: providing a stationary apparatus, and connecting the stationary apparatus to the pipeline; transmitting acoustic signals from the stationary apparatus into the pipeline, wherein each of the acoustic signals comprises an identifier code that is representative of a transmission time of the respective acoustic signal; receiving at the stationary apparatus a plurality of reflected acoustic signals; linking the acoustic signals with the reflected acoustic signals based on the identifier codes present in the reflected acoustic signal; and calculating a location of the obstacle relative to the stationary apparatus based on the transmission time of the acoustic signal, a reception time of the reflected acoustic signal, and a velocity of the acoustic signals inside the pipeline.

Other aspects and features of the teachings disclosed herein will become apparent, to those ordinarily skilled in the art, upon review of the following description of the specific examples of the specification.

### DRAWINGS

The drawings included herewith are for illustrating various examples of articles, methods, and apparatuses of the present specification and are not intended to limit the scope of what is taught in any way. In the drawings:

FIG. 1 is a block diagram showing electronic components of sensor units of a mobile apparatus;

FIG. 2 is a circuit diagram showing circuitry of a pressure sensor unit of the mobile apparatus;

FIG. 3 is a circuit diagram showing circuitry of a temperature sensor unit of the mobile apparatus;

FIG. 4 is a circuit diagram showing circuitry of an acoustic emissions (AE) sensor unit of the mobile apparatus;

FIG. 5 is a block diagram showing electronic components of a phase meter of the mobile apparatus;

FIG. 6 is a circuit diagram showing circuitry of the phase meter of FIG. 5;

FIG. 7 is a block diagram showing electronic components of the mobile apparatus;

FIG. 8 is a side schematic view of the mobile apparatus of FIG. 7;

FIG. 9 is a block diagram showing electronic components of a stationary apparatus;

FIGS. 10 to 13 are side, partial, schematic views of acoustic signal transmitters of the stationary apparatus;

FIGS. 14 and 15 are schematic diagrams of the mobile apparatus and the stationary apparatus inside a pipeline;

FIG. 16 is a flowchart of a method of controlling a mobile apparatus inside a pipeline;

FIG. 17 is a flowchart of a method of controlling a mobile apparatus and a stationary apparatus inside a pipeline; and

FIG. 18 is a flowchart of a method of controlling a stationary apparatus inside a pipeline.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limited to the scope of the example embodiments described herein.

Pipelines formed of different materials and constructed according to various sizes and shapes are used to transfer fluids from one location to the other. The material being transferred can be liquid, such as water or oil, gaseous, such as natural gas or other derivatives, or a combination thereof. Pipelines can vary widely in size and the material. For example, pipelines used for water distribution can have low pressure (a few bar), and can be made of plastic materials, such as PVC. In contrast, pipelines used for the transfer of crude oil or natural gas can be operated at high pressure (tens of bars), and are typically made of steel. Depending on their application, pipelines can be less than a few inches in diameter or as large as tens of inches in diameter. Pipelines can be installed aboveground or can be buried, either underground or submerged underneath seawater. Holes or cracks in the pipelines can result in a waste of material and can be a source of environmental damage or lead to catastrophes, such as an explosion or leakage of poisonous gas to the environment. Leakage can be due to bad connection or welding of the pieces of the pipeline during installation, corrosion, earthquake or other factors. In any case, it can be desirable to quickly detect leakage location in the pipeline and repair the leak to prevent the loss of material and any undesirable consequences. Quick detection of leakage and its location is desirable, particularly when the pipeline is long and buried underground or submersed underwater.

Methods of leak detection in use today include infrared spectroscopy, tracer gas, acoustic emission and electrical parameter measurements, or the use of moving vessels, such as a pipeline inspection gauge (PIG). These methods may require a complete shutdown of a section, or the entire pipeline, in order to inspect the pipe sections for potential leaks. For instance, in pipelines carrying media such as natural gas or crude oil, the pipeline is shut down to enable the use of sophisticated PIG systems. This method may be costly due to the downtime of the commercial pipeline, as well as the high costs that may be associated with operating the PIG system. Other lower-cost, stationary, external measurements are sometimes used, which may not provide consistently reliable and accurate data.

Described herein are methods of apparatuses for measuring conditions inside a pipeline, leak detection and/or positioning for gas or liquid pipelines using reflectometry. The teachings described herein may allow for consistent and reliable measurement of conditions of the pipeline, as measurements are taken from inside the pipe. In some cases, the leak detection may be carried out without complete shutdown of a section, or the entire pipeline.

A mobile apparatus for a pipeline can take the form of a self-contained module that travels through the pipeline and generally continuously measures the conditions inside the pipeline, surrounding the mobile apparatus, to detect leakages inside the pipeline and to record the location of the detected leakages.

The material being transferred in a pressurized pipeline, which may be liquid or gas, may leak to the surroundings through holes or cracks in the pipeline wall. The leakage process causes a variety of changes in the conditions inside the pipeline in the vicinity of where leakage takes place, such as changes in pressure, temperature and presence of acoustic emissions (AE). As described herein, at least some of these conditions can be measured to detect the presence of and locate the position of a leakage in the pipeline wall. More than one of the conditions may be measured such that the correlation of two or more of the condition measurements can be used to precisely detect the presence of a leakage in the pipeline.

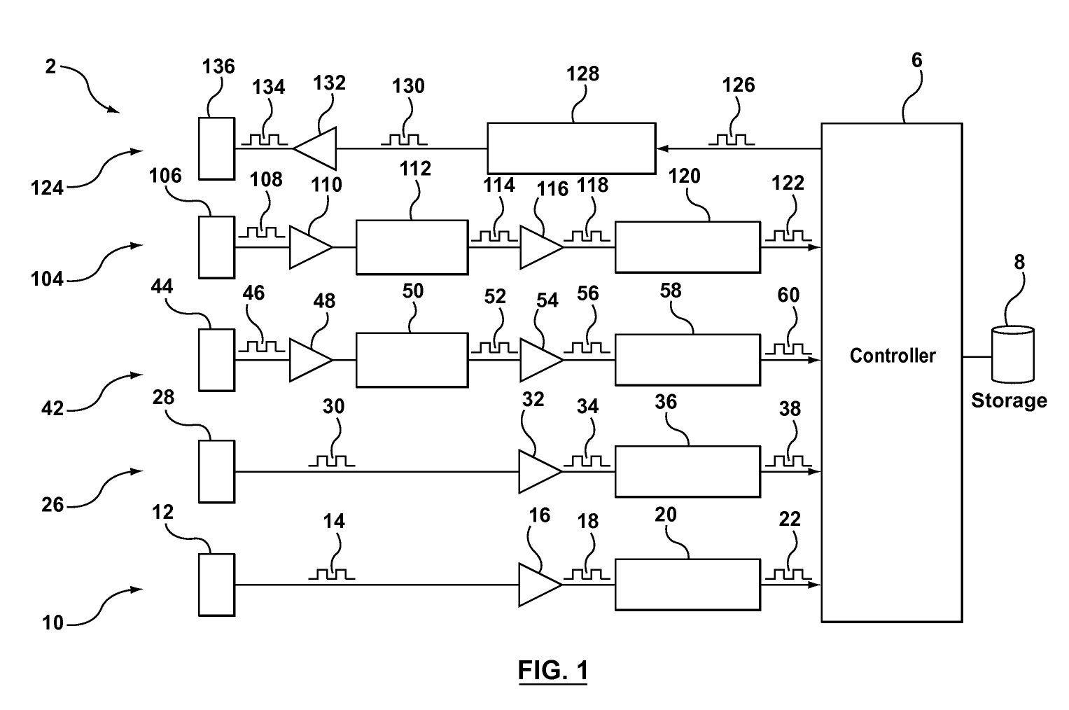

Referring to FIG. 1, illustrated therein is an example of a mobile reflectometry apparatus 2, which comprises one or more condition sensor units, a controller 6, and a memory device 8. The one or more sensor units measure one or more conditions inside the pipeline immediately surrounding the mobile apparatus 2. Each measured condition may be indicative of the presence of a leak in the pipeline through which the mobile apparatus 2 is traveling.

In various examples, the controller 6 can be implemented on a programmable processing device, such as a microprocessor or microcontroller, Central Processing Unit (CPU), Digital Signal Processor (DSP), Field Programmable Gate Array (FPGA), application-specific integrated circuit (ASIC), and the like. The memory device 8 can include non-transitory storage media, both volatile and non-volatile, including but not limited to, random access memory (RAM), dynamic random access memory (DRAM), static random access memory (SRAM), flash memory, magnetic media, and optical media.

A first sensor unit may be a pressure sensor unit 10 configured to measure the level of pressure in the surroundings of the mobile apparatus 2. Where a pipeline does not have a leak, the amount of pressure in the pipeline should be generally constant along its length. In contrast, a pipeline having a leak will generally exhibit a pressure drop in the vicinity of the leak. Generally, the magnitude of the pressure drop will depend on the extent and the size of the leak.

The pressure sensor unit 10 comprises a pressure sensor 12, which may be of the strain gauge type and which may be installed on an external surface of mobile apparatus 2 for pressure measurement. The pressure sensor 12 can be connected to the electronic circuits inside the mobile apparatus 2 through a high pressure feedthrough. The pressure sensor 12 generates a pressure sensor signal 14 from measuring the pressure in its surroundings. A pressure sensor amplifier 16 amplifies the pressure sensor signal 14 to output an amplified pressure sensor signal 18. A pressure sensor analog-to-digital converter 20 further converts the amplified pressure sensor signal 18 to digital pressure sensor data 22, which is received by the controller 6 and can be stored in memory device 8.

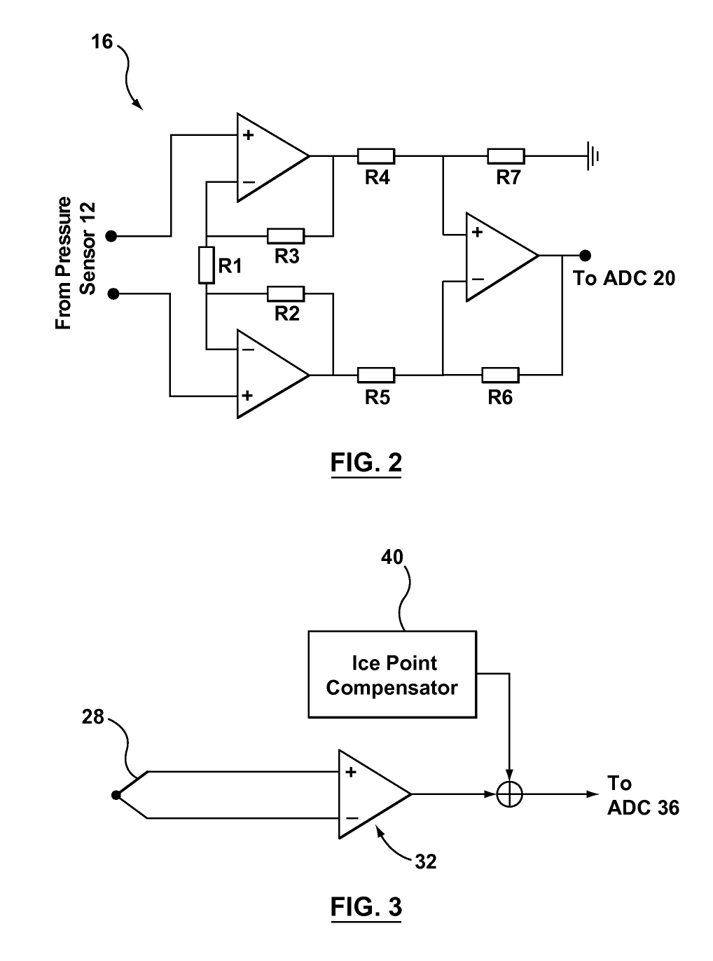

FIG. 2 illustrates an example circuitry of the pressure sensor amplifier 16 linking the pressure sensor 12 and the pressure sensor analog-to-digital converter 20; however, it will be understood that other implementations of the pressure sensor amplifier 16 are possible.

Referring back to FIG. 1, a second sensor unit may be a temperature sensor unit 26 configured to measure the temperature in the surroundings of the mobile apparatus 2. As in the case of pipeline pressure, where a pipeline does not have a leak, the temperature in the pipeline should be generally constant along its length. In contrast, a pipeline having a leak will exhibit a temperature difference in the vicinity of the leak. However, contrary to the pressure profile, temperature inside the pipeline typically recovers at some distance away from the leak.

The temperature sensor unit 26 comprises a temperature sensor 28 installed on an external surface of the mobile apparatus 2. In some particular examples, the temperature sensor 28 may comprise four thermocouples that are installed on an external surface of the mobile apparatus 2, oriented circumferentially and at 90-degree angles relative to one another. Each thermocouple of the temperature sensor 28 can be electrically connected to the electronics of the mobile apparatus 2 through a high pressure feedthrough. The temperature sensor 28 generates a temperature sensor signal 30 from measuring the temperature in its surroundings. A temperature sensor amplifier 32 amplifies the temperature sensor signal 30 to output an amplified temperature sensor signal 34. A temperature sensor analog-to-digital converter 36 further converts the amplified temperature sensor signal 34 to output digital temperature sensor data 38, which is received by the controller 6 and can be stored in the memory device 8.

FIG. 3 illustrates an example circuitry linking the temperature sensor 28 and the temperature sensor analog-to-digital converter 36, which comprises the temperature sensor amplifier 32 and an ice point compensator 40; however, it will be understood that other implementations of this interface are possible. The ice point compensator 40 can be an electronic circuit that generates a reference voltage corresponding to a known temperature. The output voltage of the temperature sensor 28 can then compared to the reference voltage to derive the actual temperature. The ice point compensator 40 can be an off-the-shelf integrated circuit, for example, an AD594™ chip (Analog Devices, Inc., of Norwood, Mass., U.S.A.).

Referring back to FIG. 1, a third sensor unit may be an acoustic emissions (AE) sensor unit 42 configured to measure amplitude and frequency of acoustic signals in a wide range of frequencies in the surroundings of the mobile apparatus 2. Leakage from a hole or crack on the pipeline wall can produce acoustic vibrations in a fairly wide range of frequencies. Acoustic signal frequency, in general, can be from a few Hz up to the MHz range, or more particularly, for this application, a frequency range of about 100 Hz to about 3 kHz. A leak can be detected by searching, along the pipeline, for locations where the amplitude of the acoustic signals reach a maximum.

The AE sensor unit 42 comprises an AE sensor 44, which may be a typical acoustic signal receiver known in the art, such as a transducer. The AE sensor 44 generates an AE sensor signal 46 that is fed to a preamplifier 48. The AE sensor signal 46 is fed through the preamplifier 48 for primary amplification, and through a band-pass filter 50 to limit the signal to only a frequency range of interest. A filtered AE sensor signal 52 is then amplified by an AE sensor amplifier 54 to output an amplified AE sensor signal 56. An AE sensor analog-to-digital converter 58 further converts the amplified AE sensor signal 56 to digital AE sensor data 60, which is received by the controller 6 and can be stored in memory device 8.

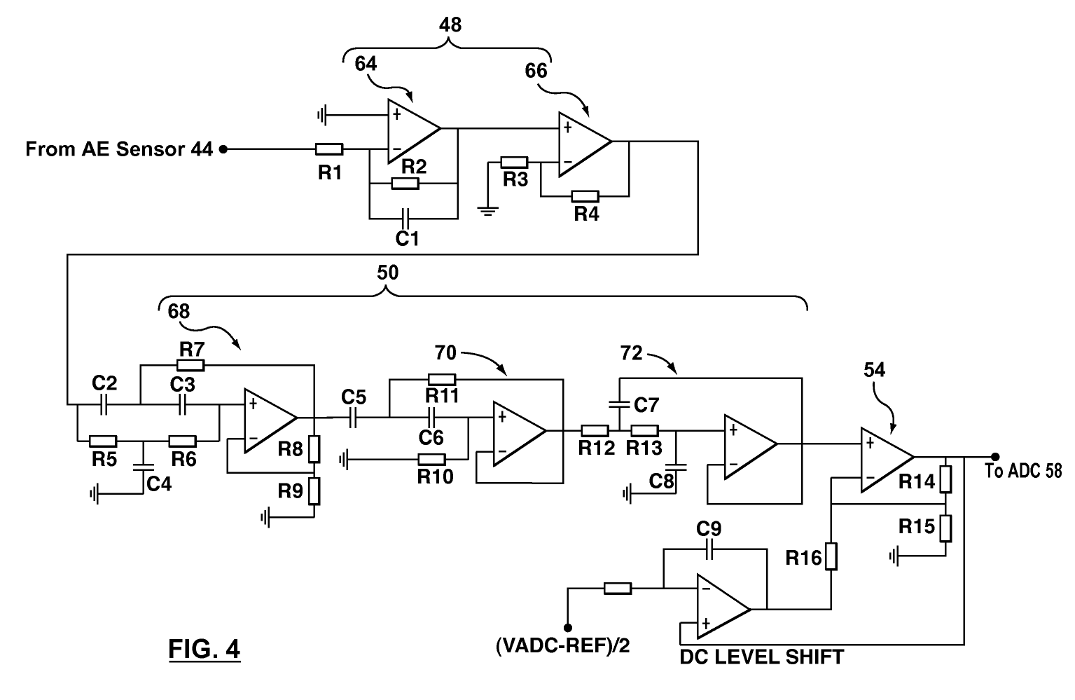

FIG. 4 illustrates an example circuitry linking the AE sensor 44 to the AE sensor analog-to-digital converter 58. As illustrated, the preamplifier 48 can comprise first and second preamplifiers 64, 66 in a preamplifier stage, the band-pass filter 50 can comprise a notch filter 68 and high-pass and low-pass filters 70, 72, and the amplifier 54 can connect to the AE sensor analog-to-digital converter 58; however, it will be understood that other implementations of this interface are possible.

Since each of a pressure condition, temperature condition, or AE presence may be used to detect a leakage in the pipeline, the mobile apparatus 2 may include any one of the pressure sensor unit 10, temperature sensor unit 26 or AE sensor unit 42. However, the mobile apparatus 2 may comprise two of these sensor units to more reliably detect the presence of a leakage in the pipeline. In some examples of the mobile apparatus 2, all three of the pressure sensor unit 10, temperature sensor unit 26 and AE sensor unit 42 can be included such that the correlation of measurements taken by all three sensors 12, 28, 44 of the surrounding conditions can be used to precisely detect the presence of leakage along the pipeline.

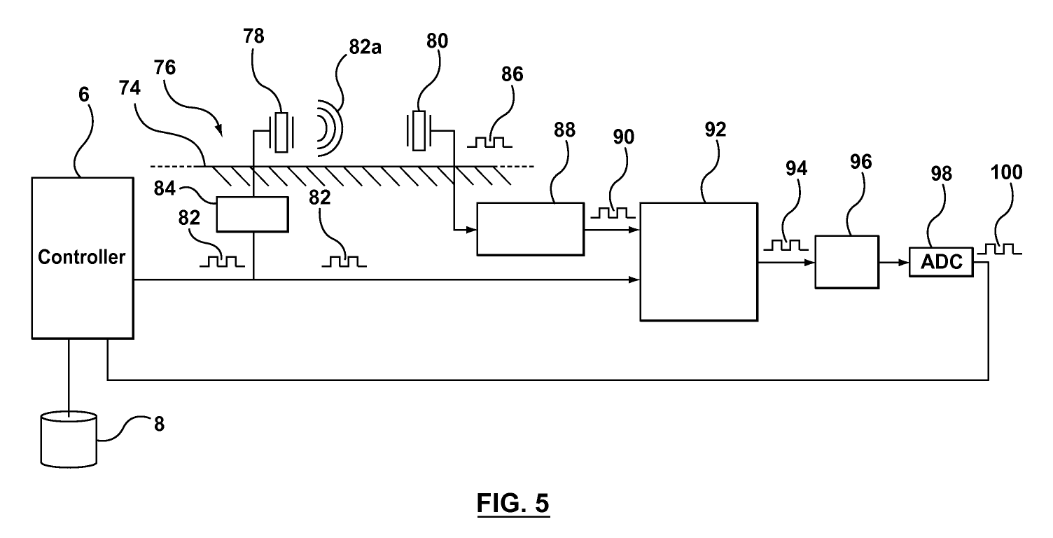

In some examples, in addition to the at least one condition sensor, the mobile apparatus 2 further comprises a phase meter 76, shown schematically in FIG. 5. The phase meter 76 can effectively senses the phase of the material (physical state of matter) surrounding the mobile apparatus 2 inside the pipeline by measuring the density of the surrounding material. The phase meter 76 can therefore detect the change in phase, for example from gas to liquid, or vice versa, in the pipeline. The phase meter 76 comprises a piezoelectric transmitter 78 and a piezoelectric receiver 80, which can be installed on an external surface 74 of the mobile apparatus 2, and can be electrically connected to the electronics of the mobile apparatus 2 through a high pressure feedthrough.

The controller 6 generates a phase detection signal 82, which is driven by a signal driver 84, and the piezoelectric transmitter 78 transmits a phase detection signal 82a through the material surrounding the mobile apparatus 2. The piezoelectric receiver 80 receives the phase detection signal 82a and generates a received phase detection signal 86. The received phase detection signal 86 is amplified by a piezoelectric receiver amplifier 88 to generate an amplified phase detection signal 90. The phase detection signal 82 and the amplified phase detection signal 90 are both inputted into a phase detector 92. The phase detector 92 compares the two signals 82, 90 to calculate a delay between the two signals, indicating a travel time of the phase detection signal 82 from the piezoelectric transmitter 78 to the piezoelectric receiver 80. The travel time is indicative of the phase of the material inside the pipeline surrounding the mobile apparatus 2. A phase detector output 94 is filtered by a low-pass filter 96 and is converted by a phase meter analog-to-digital converter 98 to output digital phase detection data 100. The digital phase detection data 100 is read by the controller 6 and can be stored in memory device 8. The controller 6 calculates a travel time and determines the phase of the material from the digital phase detection data 100. The controller 6 may further determine a velocity of an acoustic signal propagating through the material surrounding the mobile apparatus 2.

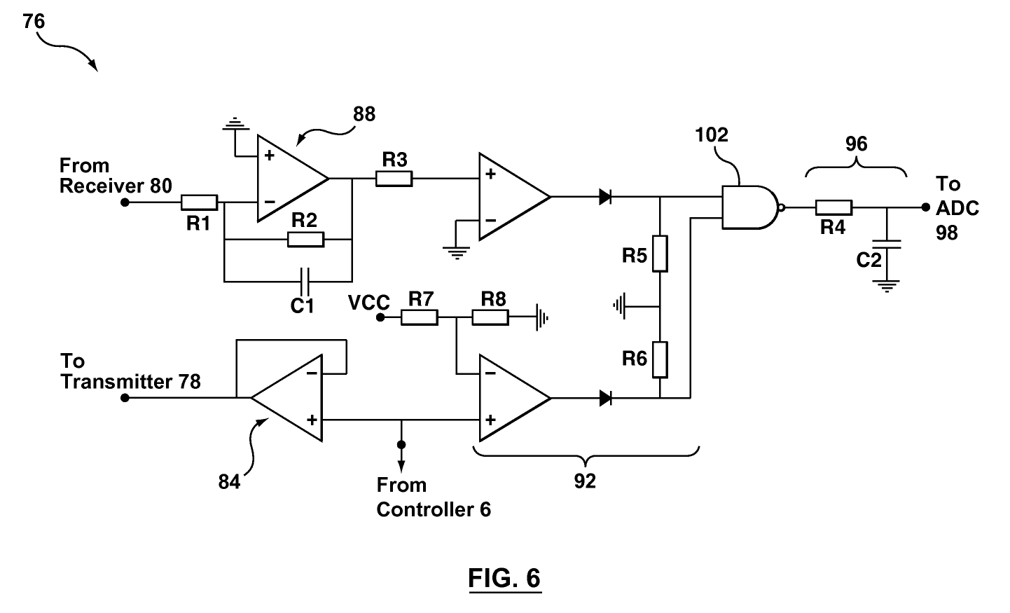

FIG. 6 illustrates an example circuitry of the phase meter 76, comprising the piezoelectric receiver amplifier 88, the signal driver 84, the phase detector 92, a NAND gate 102, and the low-pass filter 96.

Referring back to FIG. 1, in some examples, in addition to the one or more sensor units and the phase meter 76, the mobile apparatus 2 further comprises an acoustic signal receiver unit 104 configured to receive acoustic signals transmitted from an acoustic signal transmitter (not yet shown). As described herein, the reception of acoustic signals may allow for the determination of the location of the mobile apparatus 2 in relation to the acoustic signal transmitter, which corresponds to a location inside the pipeline. Like the AE sensor unit 42, the acoustic signal receiver unit 104 may include an acoustic signal receiver 106, which may be a typical acoustic signal receiver known in the art, such as a transducer. In some examples, the acoustic signal receiver unit 104 may be similar to the AE sensor unit 42, in that a received acoustic signal 108 is fed to a preamplifier 110 and passed through a band-pass filter 112 to output a filtered received acoustic signal 114. The filtered received acoustic signal 114 is fed to an amplifier 116 to output an amplified received acoustic signal 118. The amplified received acoustic signal 118 is converted by an acoustic signal receiver analog-to-digital converter 120 to output digital received acoustic signal data 122, which is read by the controller 6 and can be stored in memory device 8.

In some examples, the only difference between the AE sensor unit 42 and the acoustic signal receiver unit 104 is that the band-pass filter 112 may be specifically tuned to a frequency range of the acoustic signals. Typically, the acoustic signals will have a frequency of a few Hz to hundreds of Hz. Referring back to FIG. 4, signals that are received by the AE sensor unit 42 are primarily amplified through the first and second preamplifiers 64, 66 of the preamplifier 48. The amplified signal is then fed to the notch filter 68, which can be tuned specifically to remove the potentially interfering signal from the stationary apparatus (not yet shown). The high-pass and low-pass filters 70, 72 can further remove other unwanted signals around the AE spectrum.

In some examples of the mobile apparatus 2, the AE sensor unit 42 and the acoustic signal receiver unit 104 may share one or more components. For example, the AE sensor 44 and acoustic signal receiver 106 may be replaced with a single transducer for receiving acoustic signals. Likewise, the preamplifier 48 and the preamplifier 110 may also be replaced with a single preamplifier. The output of the single preamplifier can then be split into two paths, the first path feeding into the band-pass filter 50, tuned to the frequency range of acoustic signals, and the second path feeding into the band-pass filter 112, tuned to the frequency range of the acoustic signals. Furthermore, the AE sensor analog-to-digital converter 58 and the acoustic signal receiver analog-to-digital converter 120 may be replaced with a single multi-channel analog-to-digital converter for concurrent conversion of the amplified AE sensor signal 56 and the amplified received acoustic signal 118.

The mobile apparatus 2 may also include an emergency transmitter unit 124 for transmitting an emergency signal to any receiver in the pipeline adapted to receive the signal. In some examples, the receiver may be the acoustic signal transmitter (not shown) that sends acoustic signals. A digital emergency signal 126 is generated by the controller 6, which is converted to an analog emergency signal 130 by a digital-to-analog converter 128, and amplified by an emergency transmitter amplifier 132. An amplified analog emergency signal 134 outputted from the emergency transmitter amplifier 132 is sent by an emergency transmitter 136 as an emergency signal. The emergency transmitter 136 installed on an external surface of the mobile apparatus 2, which can be electrically connected to other electronics of the emergency transmitter unit 124 through a high pressure feedthrough.

The controller 6 is configured to control various operations carried out by the mobile apparatus 2. In particular, the controller 6 controls each of the one or more sensors units 10, 26, 42 and the phase meter 76 of the mobile apparatus 2 to measure, generally continuously, periodically and/or intermittently, the conditions surrounding the mobile apparatus 2, such as temperature, pressure, amplitude of acoustic emissions and/or phase. The controller 6 is also configured to store in the memory device 8 data pertaining to measured conditions received by the controller 6 from the sensors units 10, 26, 42 and the phase meter 76.

The controller 6 also controls the acoustic signal receiver unit 104 of the mobile apparatus 2 to receive, generally continuously, periodically and/or intermittently, acoustic signals transmitted from the acoustic signal transmitter (not shown). Digital received acoustic signal data 122 representing the received acoustic signals is received at the controller 6 and can be stored in the memory device 8. As described in further detail below, an identifier code encoded in the acoustic signals is received at the controller 6 and can be stored in memory device 8. The identifier code can allow for the location of the mobile apparatus 2 to be determined with respect to the acoustic signal transmitter, at the time the acoustic signal is received at the mobile apparatus 2. Location in this case can refer to a location with respect to the acoustic signal transmitter, which may correspond to a location inside the pipeline.

To determine the location at which each of the measured conditions is taken by the various sensors of the mobile apparatus 2, the controller 6 can associate or link each measured condition to an identifier code of a currently received acoustic signal when storing the data pertaining to the measured conditions and the identifier code in the memory device 8. The associating can be based on the time at which the condition is measured and the time at which the acoustic signal is received at the mobile apparatus 2, wherein a measured condition that is taken at approximately the same time as the reception of a acoustic signal will have data pertaining to the measured condition associated with the identifier code of that particular acoustic signal when stored by the controller 6 in the memory device 8. As it will be appreciated, where more than one condition is measured at approximately the same time as the reception of an acoustic signal, each of the measured conditions will be associated with the same identifier code when stored by the controller 6.

In some examples, where the acoustic signal transmitter transmits acoustic signals periodically within the pipeline, and the duration of the period at which the acoustic signals are transmitted is predetermined and known by the controller 6, and the velocity of the acoustic signals through the material inside the pipeline is also known, the controller 6 can be configured to calculate a current velocity of the mobile apparatus 2 for a currently received acoustic signal. This calculation of velocity may be done using arithmetic operations based on the acoustic signal period, the acoustic signal velocity inside the pipeline, and the difference in time between the currently received acoustic signal and a previously received acoustic signal. Alternatively, or in addition, the controller 6 can also be configured to calculate a current location of the mobile apparatus 2 for the currently received acoustic signal based on the acoustic signal period, the acoustic signal velocity, and the difference in time between the currently received acoustic signal, a previously received acoustic signal and a previous location of the mobile apparatus 2 when the previously received acoustic signal was received. In these examples, when stored by the controller 6, each measured condition may also be associated with the calculated velocity and/or location of the mobile apparatus 2 at approximately the same time as the measured condition. Each measured condition, the calculated velocity and/or location, and the identifier codes may all be associated by the controller 6.

Where the duration of the period of the acoustic signals is predetermined and known to the controller 6, the controller 6 may also be configured to determine whether the mobile apparatus 2 is motionless. An immobile mobile apparatus 2 may indicate that the mobile apparatus 2 is stuck or otherwise entrapped inside the pipeline. This determination may be made by comparing the difference in time between the reception time of a currently received acoustic signal and the reception time of a previously received acoustic signal. If the controller 6 determines that the mobile apparatus 2 is stationary, the controller 6 can turn on the emergency transmitter unit 124 and generate the digital emergency signal 126 to be transmitted by the emergency transmitter 136. In examples where the controller 6 does not calculate a current location of the mobile apparatus 2, the digital emergency signal 126 generated by the controller can inform any receiver adapted to receive the emergency signal that the mobile apparatus 2 is stationary. In other examples, where the controller 6 is configured to calculate a current location of the mobile apparatus 2, the digital emergency signal 126 may additionally contain information pertaining to the currently calculated location of the mobile apparatus 2. This additional information allows the mobile apparatus 2 to be found if rescue operations are required to free the mobile apparatus 2 and/or resume its travel through the pipeline. When the mobile apparatus 2 is not stationary, the emergency transmitter unit 124 can be turned off to reduce power consumption.

The mobile apparatus 2 comprises output means to allow an external device to read the data stored in the memory device 8. Typically, the stored data is read after the mobile apparatus 2 has completed traveling through the pipeline and has been extracted. In some examples, the output means may be a conventional USB port known in the art. However, other known means for outputting data are possible, including, for example but without limitation, wireless means of transmitting the data stored in the memory device 8.

In some particular examples, the mobile apparatus 2 is designed to be small in size and the electronic components of the mobile apparatus 2 are selected and configured to consume relatively low power. Since the mobile apparatus 2 must travel through the pipeline, a small size allows it to move more freely through the pipeline. Furthermore, in many applications, the mobile apparatus 2 will have a slow movement through the pipeline, i.e. due to the slow movement of material in the pipeline, and a length of the pipeline can be substantial, and therefore electronic components of the mobile apparatus 2 may have low power consumption to allow the mobile apparatus 2 to remain operational during the entire time that it is traveling through the pipeline. For example, in some applications, the mobile apparatus 2 may remain inside the pipeline for as long as tens of hours, during which time it can remain operational. The low power consumption of the electronic components of the mobile apparatus 2 allows for a battery powering the components to made as small and lightweight as possible, which also allows reduction of the size of the mobile apparatus 2.

A first way of lowering power consumption of the electronic components of the mobile apparatus 2 is to select a low clock frequency for the controller 6.

A second way of lowering power consumption and size of the mobile apparatus 2 is to eliminate duplication of parts. For example, referring back to FIG. 1, it has already been described that the AE sensor unit 42 and the acoustic signal receiver unit 104 may be combined to share a single transducer for receiving acoustic signals and a single preamplifier. In another example, analog-to-digital converters 20, 36, 58, and 120 can be integrated to be a single analog-to-digital converter to be used in conjunction with a suitable multiplexer switch for selecting the analog signal to be converted.

A third way of lowering power consumption is to select or configure components to use the lowest power necessary. For example, the multiple amplifiers 16, 32, 54, and 116 can be configured to use the lowest power and voltage necessary for the functioning of the corresponding components. Furthermore, the sensors units 10, 26, 42 can be turned on only when required, and kept off at all other times. For example, as described above, emergency transmitter unit 124 can be turned on to transmit an emergency signal only if controller 6 determines that the mobile apparatus 2 is stationary.

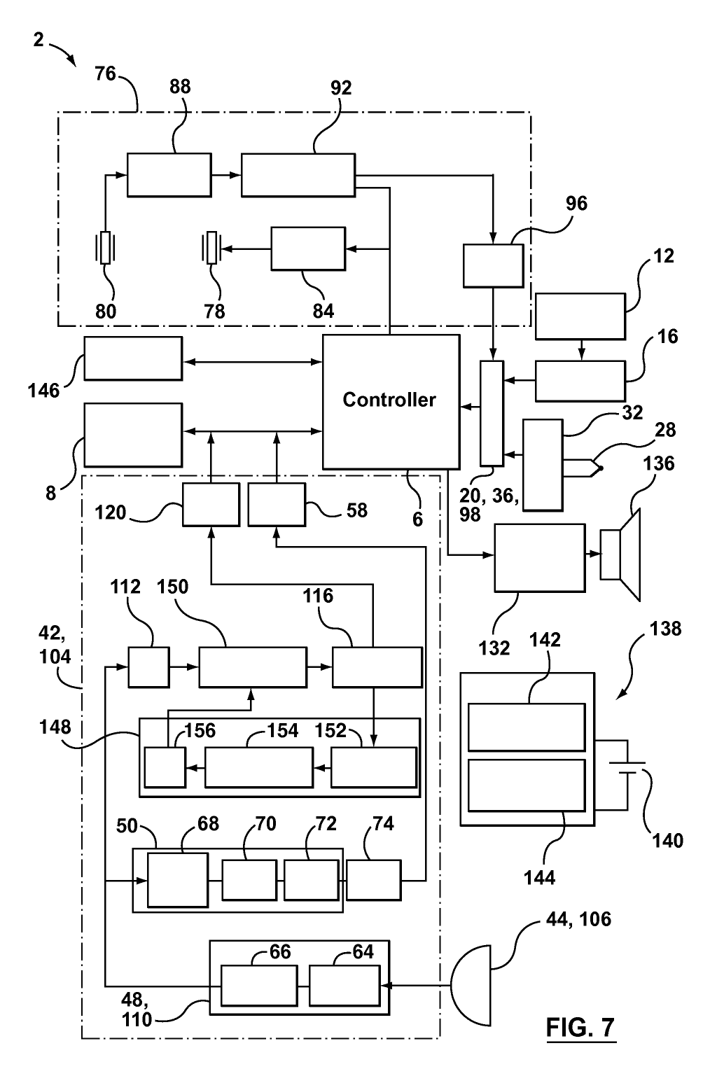

The mobile apparatus 2 is illustrated in FIG. 7. In the example illustrated, the AE sensor unit 42 and the acoustic signal receiver unit 104 and have been substantially combined. The AE sensor 44 and the acoustic signal receiver 106 are integrated into a single transducer, which provides analog data to the preamplifier 48, 110, which consists of first and second preamplifiers 64, 66. Furthermore, the pressure sensor 12, the temperature sensor 28, and phase meter 76 are shown to share a single analog-to-digital converter 20, 36, 98. A power supply 138, fed by a battery 140 that may be chargeable, is also shown to comprise a regulator 142 and a switching converter 144. An output means 146 is shown linked to the controller 6, which allows an external device to connect to the controller 6 and read the data stored in the memory device 8. The amplifier 116 is output to an automatic gain control (AGC) unit 148 and an attenuator 150, which serves to reduce desensitization due to relatively large signals or interference that may be present in the signal coming from the band-pass filter 112. The AGC unit 148 comprises an RMS-to-DC converter 152, a comparator 154, and a low-pass filter 156. The AGC unit 148 is connected to the attenuator 150, which is linked between the band-pass filter 112 and the amplifier 116. It will be appreciated that when the mobile apparatus 2 is relatively close to an acoustic signal transmitter of the stationary apparatus (not yet shown), the acoustic signal that reaches the mobile apparatus 2 may be too strong and may cause saturation in the preamplifiers 64, 66. The AGC unit 148 can measure the amplitude of the received acoustic signal, and can adjust the system gain by adjusting the loss of the attenuator 150, to avoid saturation. The AGC unit 148 can be included for the acoustic signal receiver unit 104, but is not necessary for the AE sensor unit 42 because the acoustic signal from the stationary apparatus can be removed by the notch filter 68.

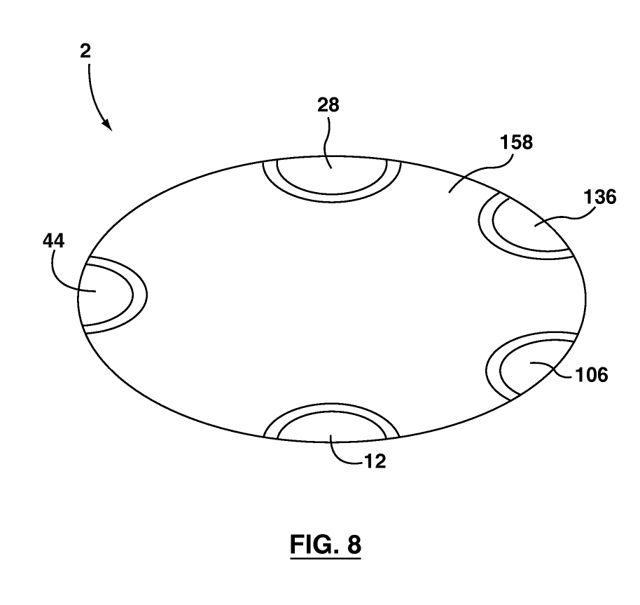

Referring now to FIG. 8, schematically illustrated therein is an example of the mobile apparatus 2. The mobile apparatus comprises an outer shell 158 defining a housing of the mobile apparatus 2. The various electronic components are housed within the housing, while the pressure sensor 12, the temperature sensor 28, the AE sensor 44, the acoustic signal receiver 106 and emergency transmitter 136 can be installed on an external surface of the outer shell 158. As described previously, these components can be connected to the various electronics inside the housing through high pressure feedthroughs, which can be capable of withstanding pressures of up to 150 bars, for example.

In some examples, the mobile apparatus 2 is designed to be propelled by fluid flowing through the pipeline in order to travel through the pipeline. The mechanical size and weight of the mobile apparatus 2 may be chosen to have approximately zero buoyancy with respect to the material being transferred by the pipeline. For different materials being transferred inside the pipeline, the size of the mobile apparatus 2 may be varied accordingly to achieve zero buoyancy in each case. In some examples, the outer shell 158 of the mobile apparatus 2 may be formed of a reinforced fiberglass material to achieve zero buoyancy while at the same time providing protection to the electronic components within the housing of the mobile apparatus 2.

In other examples, the mobile apparatus 2 can be connected to a PIG traveling through the pipeline. The PIG can either be propelled by the pressure of the material being transferred inside the pipeline, or the PIG can include its own propulsion system for traveling through the pipeline. In either case, it may not be necessary for the mobile apparatus 2 to have zero buoyancy with respect to the material being transferred by the pipeline. In these examples, the outer case of the mobile apparatus 2 may be formed of aluminum or steel.

It will be appreciated that the shape of the outer shell 158 of the mobile apparatus 2 can vary, depending on the application. In examples where the mobile apparatus 2 is connected to a PIG traveling through the pipeline, the outer shell 158 can be generally cylindrical in shape, whereas self-propelled examples of the mobile apparatus 2 can be more rounded in shape to move easily with the flow of fluid in the pipeline, such as that illustrated in FIG. 8 in which the outer shell 158 generally takes the form of a “football” shape (a prolate spheroid).

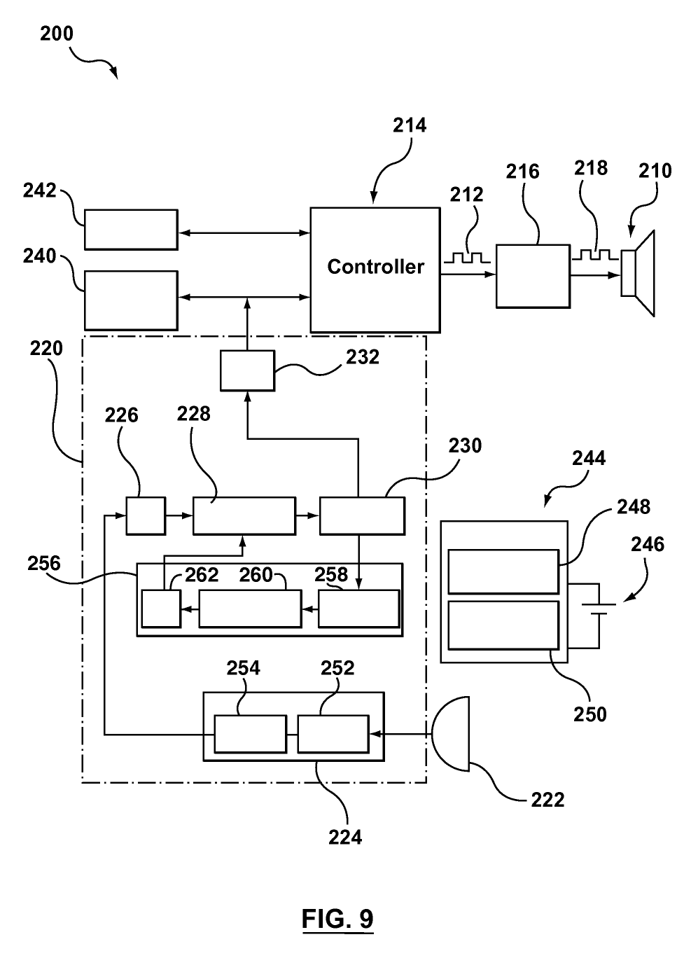

A stationary reflectometry apparatus 200 is illustrated in FIG. 9. The stationary apparatus 200 can be installed at the inlet of a pipeline and can transmit acoustic signals to be received by the mobile apparatus 2, generally as described above. The stationary apparatus 200 comprises an acoustic signal transmitter 210 for transmitting relatively high power and low frequency acoustic signals from a fixed location inside the pipeline. A low-power signal 212 is generated by a controller 214 and is amplified by a power amplifier 216, which may be a pulse-width modulation (PWM) amplifier. The controller 214 can be similar to the controller 6 described above. A high power signal 218 outputted from the power amplifier 216 is fed to the acoustic signal transmitter 210 for transmitting high power low frequency acoustic signals.

The stationary apparatus 200 also comprises an acoustic signal receiver unit 220, which may be similar to the acoustic signal receiver unit 104 of the mobile apparatus 2. The acoustic signal receiver unit 220 comprises an acoustic signal receiver 222, and a pre-amplifier 224, which can consist of a first preamplifier 252 and a second preamplifier 254. The acoustic signal receiver unit 220 further comprises a band-pass filter 226, an amplifier 230 and an analog-to-digital converter 232. The amplifier 230 is output to an AGC unit 256 and an attenuator 228, which serves to reduce desensitization due to relatively large signals or interference that may be present in the signal coming from the band-pass filter 226. The AGC unit 256 comprises an RMS-to-DC converter 258, a comparator 260, and a low-pass filter 262. The AGC unit 256 is connected to the attenuator 228, which is linked between the band-pass filter 226 and the amplifier 230. The AGC unit 256, in general, prevents the acoustic signal receiver unit 220 from being saturated due to strong received signals. Acoustic signals that are reflected from targets far from the stationary apparatus 200 tend to be small (weak). To detect small signals, the gain has to be relatively high. However, strong signals reflected from nearby targets may saturate the acoustic signal receiver unit 220. The AGC unit 256 can measure amplitude of the acoustic signals and adjust the gain to prevent saturation or desensitization of the acoustic signal receiver unit 220.

The stationary apparatus 200 further comprises a memory device 240 for storing data received from the acoustic signal receiver unit 220 via the controller 214. The memory device 240 can be similar to the memory device 8 described above. An output means 242 is shown linked to the controller 214, which allows an external device to connect to the controller 214 and read the data stored in the memory device 240. The output means 242 can be similar to the output means 146 described above.

A power supply 244 supplies power to the various components of the stationary apparatus 200. The power supply 244 may be fed by a chargeable battery 246. However, since the stationary apparatus 200 may be positioned at an inlet of the pipeline, the power supply 244 may alternatively be fed by a continuous electric source (not shown). The power supply 244 also comprises a regulator 248 and a switching converter 250.

The acoustic signal transmitter 210 is configured to transmit high power acoustic signals into the pipeline. For example, the acoustic signal transmitter 210 may be configured to transmit acoustic signals of about 100 W into the pipeline. Furthermore, due to attenuation of the acoustic signals inside the pipeline, and the long distance over which the acoustic signals must propagate, the acoustic signal transmitter 210 must transmit acoustic signals having appropriate power levels and frequency.

A first factor in attenuation is the frequency of the transmitted acoustic signals. Attenuation of an acoustic signal increases with the frequency of the acoustic signal. That is, higher acoustic frequencies bear larger attenuation when traveling through a pipe. Table 1 shows a calculated attenuation of acoustic signal in a pipeline. Table 2 shows the required input power for the acoustic signal to have a power of 100 mW at a distance of 40 km away from the transmitter in a pipeline with a diameter of 3 inches. Therefore, low frequency transmitted acoustic signals exhibit less attenuation and require less power.

TABLE 1
Attenuation of acoustic signals in a 3 inch pipeline.

Attenuation (dB)

| Frequency (Hz) | 10 km | 100 km |
|---|---|---|
| 2 | 4.4 | 43.6 |
| 4 | 6.2 | 61.7 |
| 8 | 8.7 | 87.1 |
| 16 | 12.3 | 123.1 |

TABLE 2
Required input power for 40 km of a 3 inch pipeline.

| Frequency (Hz) | Required input power (W) |
|---|---|
| 8 | 2.31E+00 |
| 16 | 1.47E+02 |
| 32 | 5.17E+04 |
| 64 | 2.05E+08 |

Second and third factors in attenuation are the distance over which the acoustic signal must travel, and the diameter of the pipeline. However, these factors cannot be controlled, and therefore it is necessary to design the transmitter bearing these factors in mind. For example, as seen from Table 2, even at a low frequency of 16 Hz, a minimum transmission power of 147 W is required in order for the acoustic signal to have a power of 100 mW at a distance 40 km in a pipeline having a diameter of 3 inches.

Furthermore, pipelines typically operate at high pressures, for example, from about 1 bar to as high as about 150 bar of pressure. In order to avoid shutting down the pipeline, the acoustic signal transmitter 210 must be capable of withstanding such high pressure while operating to transmit the high power and low frequency acoustic signals.

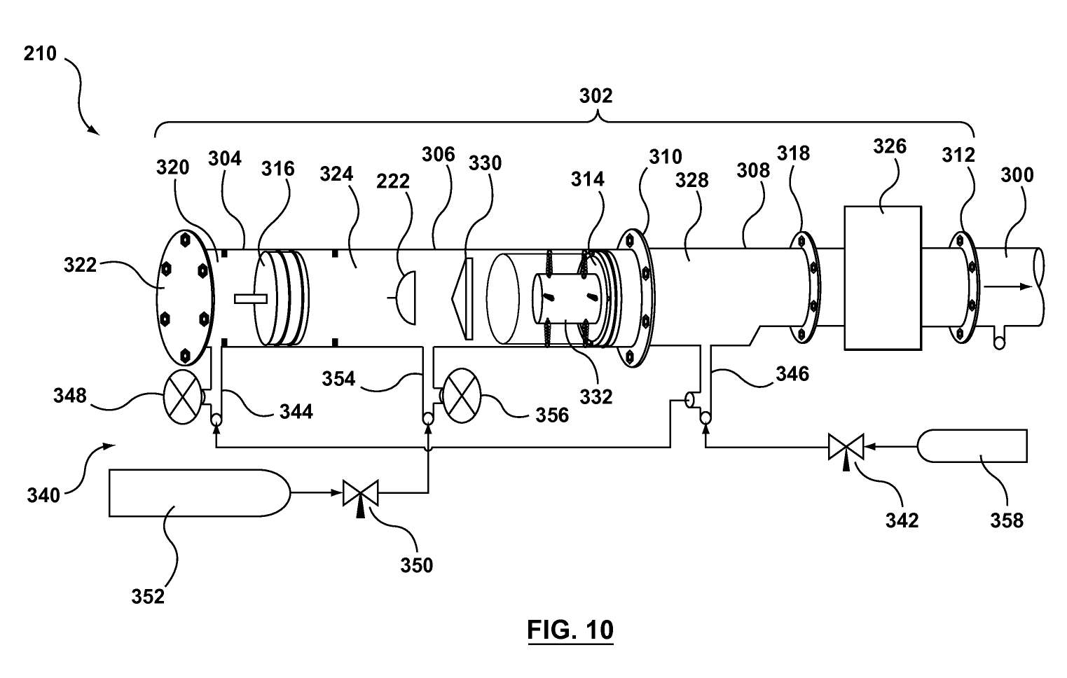

Referring to FIG. 10, illustrated therein is an example of the acoustic signal transmitter 210. The acoustic signal transmitter 210 is configured to transmit high power and low frequency acoustic signals into a pipeline 300, and is capable of withstanding high pressure. According to this example, the acoustic signal transmitter 210 comprises a cylindrical outer casing 302 formed of a first outer casing section 304, a second outer casing section 306 and third outer casing section 308. The sections 304, 306, 308 may be formed of similar structure and materials as that of the pipeline 300. As illustrated, the first outer casing section 304, the second outer casing section 306 and third outer casing section 308 may be generally contiguous and aligned in series. A distal end of the second outer casing section 306 interfaces with a proximal end of the third outer casing section 308 at a first flange 310. A distal end of third outer casing section 308 interfaces with a proximal end of the pipeline 300 at a second flange 312. The third outer casing section 308 can comprise subsections, which interface at a third flange 318.

In the second outer casing section 306, a vibrating diaphragm 314 is positioned at a distal end away from the sealing plug 316, defining a first chamber 324 therebetween. The vibrating diaphragm 314 is composed of a flexible and resilient material, and also has an outer diameter that is complementary to an inner diameter of the second outer casing section 306, to generally seal the first chamber 324. The vibrating diaphragm 314 and a pipeline valve 326 define a second chamber 328 that is generally in the third outer casing section 308. The pipeline valve 326 can be operated to open and close to allow fluid communication between the second chamber 328 and the pipeline 300. In the first outer casing section 304, an end cap 322 and a sealing plug 316 define a third chamber 320. The sealing plug 316 is composed of a rigid material, and has an outer diameter that is complementary to an inner diameter of the outer casing sections 304, 306.

The acoustic signal transmitter 210 further comprises a high power transducer 330, which may be, for example, a directional speaker. Referring back to FIG. 9, the high power transducer 330 can be connected to the controller 214 through the power amplifier 216. The low-power signal 212 generated by the controller 214 can be amplified by the power amplifier 216, and transmitted as a high power acoustic signal from the high power transducer 330.

Acoustic signals emitted from the high power transducer 330 propagate through the first chamber 324 to the vibrating diaphragm 314, thereby causing the vibrating diaphragm 314 to vibrate. This vibration causes acoustic signals to be propagated into the second chamber 328. However, due to the high power level of the acoustic signals, a portion of the acoustic signals may be reflected back to the first chamber 324 at the vibrating diaphragm 314 if the impedance of the first chamber 324 is not matched to the impedance of the pipeline 300. When the impedances are not matched, the full power of the acoustic signal may not be transmitted from the first chamber 324 into the second chamber 328.

To match the impedance from the first chamber 324 to the pipeline 300, a variable weight 332 can be coupled to the vibrating diaphragm 314. The variable weight 332 can be configured to change the effective mass and therefore the resonance frequency of the vibrating diaphragm 314. For example, a rod (not shown) can be connected to the vibrating diaphragm 314, within the first chamber 324. Variable weights (not shown) can be fastened to the rod to change the resonance frequency of the vibrating diaphragm 314. The variable weight 332 can be adjusted by adding or removing the weights to tune the impedance of the vibrating diaphragm 314 such that the impedance seen from the vibrating diaphragm 314 into the pipeline 300 matches the impedance of the first chamber 324 while the second chamber 328 is filled with pressurized fluid.

When the acoustic signal transmitter 210 is connected to the pipeline 300, pressure inside the first chamber 324 may be different from pressure inside the pipeline 300. For example, before installation, the first chamber 324 may have a pressure equal to that of the environment, which may be approximately 1 atm. In this case, the pressure of the first chamber 324 will be significantly lower than the pressure inside the pipeline 300. If the pipeline valve 326 is opened in the presence of this large difference in pressures, the higher pressure of the pipeline 300 may cause damage to the vibrating diaphragm 314. Therefore, prior to opening the pipeline valve 326, the pressure inside the first chamber 324 can be adjusted to achieve approximate pressure equalization with the pressure inside the pipeline 300.

To adjust the pressure inside the first chamber 324, the acoustic signal transmitter 210 comprises a pressure injection mechanism 340 for injecting pressurized gas or liquid into each of the third chamber 320, the first chamber 324, and/or the second chamber 328. The pressure injection mechanism 340 comprises a first injection valve 342, which is connected to a first pressurized fluid feed 358. The first injection valve 342 is connected to the third chamber 320 via a first pressure tube 344, and to the second chamber 328 via a third pressure tube 346 to selectively pass pressurized fluid from the first pressurized fluid feed 358 to the third chamber 320 and the second chamber 328. As illustrated, a first pressure gauge 348 may be installed on the first pressure tube 344 to monitor the pressure inside the third chamber 320. A similar pressure gauge can be installed on the third pressure tube 346.

The pressure injection mechanism 340 further comprises a second injection valve 350, which is connected to a second pressurized fluid feed 352. The second injection valve 350 is connected to the first chamber 324 via a second pressure tube 354 to selectively pass pressurized fluid from the second pressurized fluid feed 352 to the first chamber 324. A second pressure gauge 356 may be installed on the second pressure tube 354 to monitor the pressure inside the first chamber 324.

Where the material being transferred in the pipeline 300 is liquid, pressure equalization of the first chamber 324 can be achieved by actuating the first injection valve 342 to feed a liquid into the third chamber 320 and the second chamber 328. After filling the third chamber 320 and the second chamber 328, the second injection valve 350 can be actuated to feed a gas to fill the first chamber 324. The gas can be fed until the pressure in the first chamber 324 is substantially equal to the pressure of the liquid in the pipeline 300. In some examples, the gas fed to the second injection valve 350 may be pressurized nitrogen gas, which tends to be inexpensive, harmless, and easily accessible. After equalization of pressure, pipeline valve 326 can be opened to allow fluid communication between the second chamber 328 and the pipeline 300, and to allow transmission of the acoustic signals from the acoustic signal transmitter 210 into the pipeline 300. Operation of the valves 326, 342, 350 may be controlled by the controller 214 (FIG. 9). Alternatively, the valves 326, 342, 350 may be automatically controlled by an external control device (not shown) configured to monitor the pressure in the chambers 320, 324, 328, or the valves 326, 342, 350 may be manually controlled by a human operator.

In other examples, where the material being transferred in the pipeline 300 is pressurized gas, the valves 342, 350 can be actuated cyclically to repeatedly feed in amounts of a pressurized gas into the chambers 320, 324, 328 to incrementally increase the pressure in each. The incremental increases in pressure can be controlled to be low enough such that no damage is caused to the vibrating diaphragm 314. The pressurized gas fed to the second and third chambers 328, 320 may be generally the same as the gas being transferred in the pipeline 300. Another type of pressurized gas may be fed to the first chamber 324. Again, in some examples, the gas fed to the second injection valve 350 may be pressurized nitrogen gas.

As illustrated in FIG. 10, the acoustic signal receiver 222 may be positioned inside the first chamber 324 to receive reflected acoustic signals, transmitted from the acoustic signal transmitter 210, and reflected off of an object (not shown) in the pipeline 300, such as the mobile apparatus 2 described above. Alternatively, the acoustic signal receiver 222 may be positioned inside the second chamber 328, for example, coupled to the vibrating diaphragm 314, and connected to the controller 214 (FIG. 9) via a high pressure feedthrough. The controller 214 may also be positioned inside the first chamber 324, and connected to the high power transducer 330 and the acoustic signal receiver 222

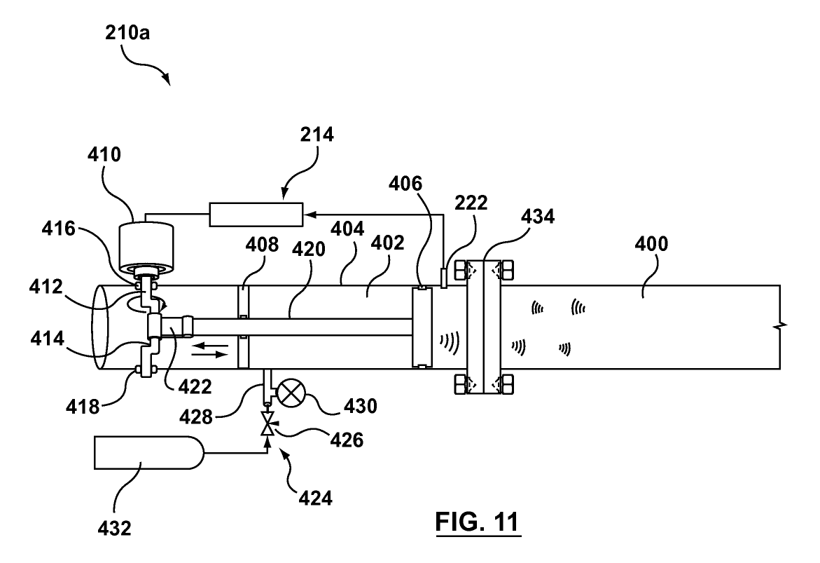

Referring now to FIG. 11, illustrated therein is another example of an acoustic signal transmitter 210a, which is configured to transmit high power and low frequency acoustic signals into a pipeline 400, and is capable of withstanding high pressure. According to this example, the acoustic signal transmitter 210a comprises a piston chamber 402 defined by an outer casing 404, which can be generally cylindrical, and a piston 406 and a chamber end wall 408 disposed within the outer casing 404. The outer casing 404 may interface with the pipeline 400 at a flange 434.

The piston 406 can form a seal with the outer casing 404 to prevent high pressure gas or liquid in the pipeline 400 from entering the piston chamber 402. Suitable high pressure packing means can also be implemented, such as gaskets, O-rings, and the like. Furthermore, an inner surface of the outer casing 404 can be relatively smooth to allow for easy movement of the piston 406 and at the same time ensure adequate sealing between the piston 406 and the outer casing 404.

According to this example, the acoustic signal transmitter 210a comprises a motor 410 and a shaft 412 driven by the motor 410. The motor 410 can be an electric motor. The shaft 412 comprises a section 414 which is offset from an axis of rotation of the shaft 412. The shaft 412 extends between and is supported by first and second bearings 416, 418, which are on generally opposing sides of the outer casing 404. A coupling rod 420 connects the shaft 412 to the piston 406, through an opening in the chamber end wall 408. An end portion 422 of the coupling rod 420 is rotatably coupled to the shaft 412, and can pivot relative to the other portion of the coupling rod 420. Rotary motion of the shaft 412 causes reciprocating motion of the coupling rod 420 and the piston 406. Reciprocating movement of the piston 406 within the piston chamber 402 can generate high power acoustic signals within the material flowing in the pipeline 400. Reciprocating movement of the piston 406 depends on the rotational velocity of the shaft 412, which is determined by the motor 410, and which may be controlled by the controller 214, or another suitable device. Furthermore, rotational velocity of the shaft 412 may be variably controlled such that the movement of the piston 406 generates acoustic signals. Input power of an acoustic signal generated through movement of the piston 406 to the pipeline 400 can be calculated as follows:

$${Power}_{( RMS )} = \frac{{ρ}_{0} {CL}^{2} {ω}^{2} S}{2} ;$$

where ρ₀ is the specific density of the material in the pipeline 400, C is the velocity of an acoustic wave, L is the displacement of the piston 406, ω is the frequency and S is the area of the cross-section of the pipeline 400. The required torque T from the motor can also be calculated as follows:

$${T}_{( RMS )} = \frac{{Power}_{( RMS )}}{ω} .$$

As an example, Table 3 gives the required torque for 200 W of input power for different frequencies.

TABLE 3
Required torque for 200 W of input power as a function of frequency.

| Frequency (Hz) | Torque (Nm) |
|---|---|
| 4 | 7.958 |
| 8 | 3.979 |
| 16 | 1.989 |
| 32 | 0.995 |
| 64 | 0.497 |
| 128 | 0.249 |

To reduce the required torque outputted from the motor 410 to cause movement of the piston 406, pressure inside the piston chamber 402 can be controlled to substantially match a pressure inside the pipeline 400. To achieve approximate pressure equalization between the piston chamber 402 and pipeline 400, the acoustic signal transmitter 210a may comprise pressure injection mechanism 424 for injection of pressurized gas into the piston chamber 402. In some examples, the injected gas may be pressurized nitrogen. The pressure injection mechanism 424 comprises an injection valve 426, which is connected to a pressurized fluid feed 432. The injection valve 426 is connected to the piston chamber 402 via a pressure tube 428. A pressure gauge 430 may be installed on the pressure tube 428 to monitor the pressure inside the piston chamber 402. To achieve equalization, pressurized gas is injected into the piston chamber until the pressure inside the piston chamber 402 is substantially the same as the pressure inside the pipeline 400.

As shown in FIG. 11, the acoustic signal receiver 222 can be positioned outside the piston chamber 402 adjacent to the piston 406. The acoustic signal receiver 222 can be connected to the controller 214 through a high pressure feedthrough.

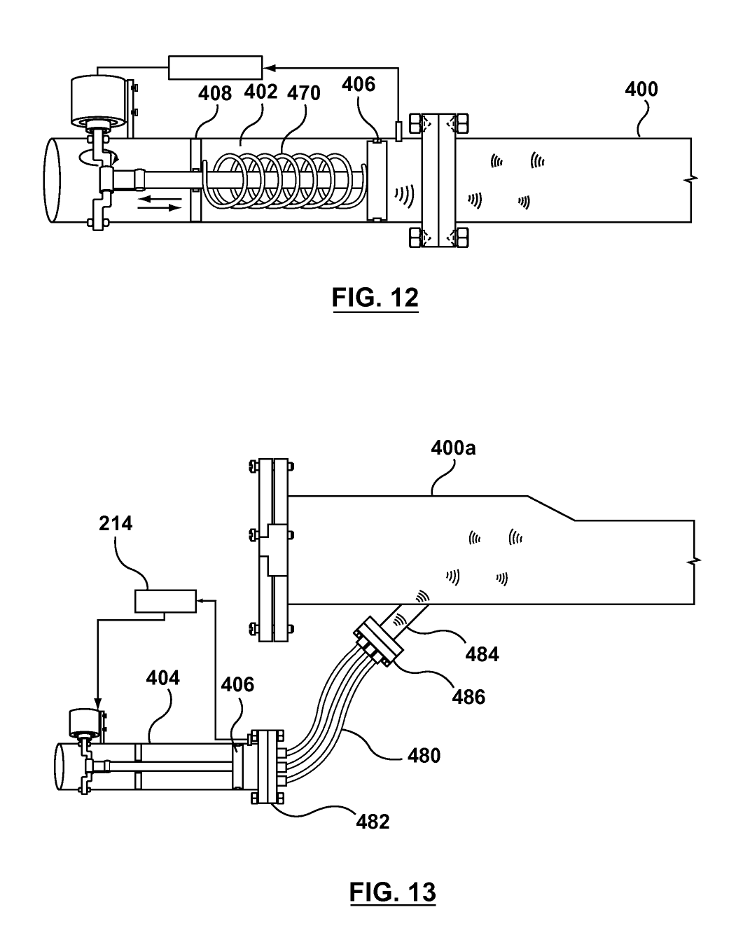

FIG. 12 illustrates a modification to the acoustic signal transmitter 210a of FIG. 11. According to this modification, one or more mechanical springs 470 extend in the piston chamber 402 between the piston 406 and the chamber end wall 408. A spring constant K of the mechanical spring 470 can be selected appropriately so that a force exerted by the mechanical spring 470 onto the piston 406 approximately counterbalances a force exerted by the pressure in the pipeline 400 onto the piston 406. Where more than one mechanical spring 470 is used, a cumulative spring constant K is selected appropriately.

FIG. 13 illustrates a further modification to the acoustic signal transmitter 210a of FIG. 11. According to this modification, the outer casing 404 is not directly coupled to a pipeline 400a. Instead, the outer casing 404 is indirectly coupled to the pipeline 400a via the use of one or more high pressure hoses 480. The high pressure hoses 480 can offer ease of installation compared to a direct connection to the pipeline; however, in operation there may be extra attenuation of acoustic signals (which can be offset by increasing the transmitted power accordingly). A first hose flange 482 couples the outer casing 404 to the high pressure hoses 480. An input feed 484 is connected to the pipeline 400a. A second hose flange 486 couples the high pressure hoses 480 to the input feed 484. High power acoustic signals generated by movement of the piston 406 travel through the high pressure hoses 480 into the pipeline 400a.

The controller 214 is configured to control various operations carried out by the stationary apparatus 200. In particular, the controller 214 controls the acoustic signal transmitter 210 to transmit acoustic signals periodically into the pipeline. In practice, the type of the acoustic signals transmitted by the acoustic signal transmitter 210 can be varied. However, in most cases periodic transmission is preferred because of the signal-to-noise ratio that is achievable when periodic pulses are used. To transmit acoustic signals, the controller 214 generates the low-power signal 212, which is amplified by power amplifier 216 and outputted as high power signal 218, as described above. The low-power signal 212 may be encoded to comprise an identifier code. For each acoustic signal, the identifier code can be unique, and can be representative of a transmission time of the particular acoustic signal from the stationary apparatus 200, so that the particular acoustic signal can be subsequently identified. In the acoustic signal transmitter 210, the high power signal 218 drives the high power transducer 330. In the acoustic signal transmitter 210a, the high power signal 218 drives the motor 410.

The controller 214 also controls the acoustic signal receiver unit 220 of the stationary apparatus 200 to receive reflected acoustic signals corresponding to the acoustic signals transmitted by the acoustic signal transmitter 210 reflected back off of an obstacle in the pipeline. The identifier code of each acoustic signal will also be present in the corresponding reflected acoustic signal, which may allow for the determination of the location of the obstacle. In particular, the controller 214 can link the transmission time of one of the acoustic signals and a reception time of the corresponding reflected acoustic signal, which presents the same identifier code, and can store data pertaining to the transmission time, reception time and the identifier code in the memory device 240. The controller 214 can be configured to calculate the distance of the obstacle from the stationary apparatus 200, which corresponds to a location of the obstacle inside the pipeline. The calculation may be done using arithmetic operations based on the transmission time, the reception time, and a velocity of any acoustic signal through the pipeline. The calculated location of the obstacle can also be store in the memory device 240 in addition to the other data.

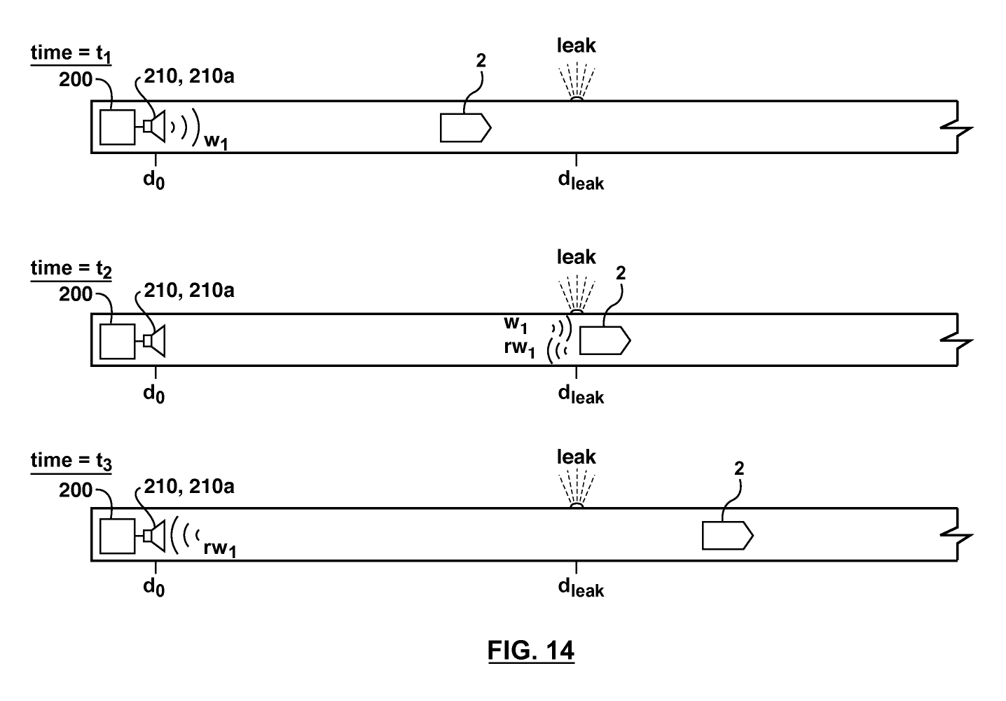

FIG. 14 illustrates the mobile apparatus 2 and the stationary apparatus 200 operated in combination to detect leakages within a pipeline. The mobile apparatus 2 is inserted into the pipeline and is traveling through it in the direction of the flow of the fluid inside the pipeline. The stationary apparatus 200 is connected to the pipeline at a fixed location.

The choice of the appropriate design of the acoustic signal transmitter 210, 210a may be made according to the type of the pipeline and the pressure inside the pipeline. For example, for low to medium pressure in the pipeline, the acoustic signal transmitter 210 (FIG. 10) may be suitable, whereas for medium to high pressure pipelines, the acoustic signal transmitter 210a (FIGS. 11 to 13) may be suitable.

To determine the location of the mobile apparatus 2 at different times as it is traveling through the pipeline, the stationary apparatus 200 can transmit acoustic signals periodically. Referring to FIG. 14, a first acoustic signal w₁ is transmitted by the stationary apparatus 200 at time t₁. Generally, to avoid interference between a transmitted signal traveling forward (away from the stationary apparatus 200) and a reflected signal travelling backward (towards the stationary apparatus 200), it can be necessary to wait for the reflected signal to be received before transmitting a new acoustic signal. This is particularly the case when the target (i.e. the leak) is relatively close to the stationary apparatus 200. In these cases, the time between two transmitted signals and the duration of each transmitted signal can be selected to avoid interference.

As explained above with reference to the controller 214 of the stationary apparatus 200, each acoustic signal can include an identifier code. The identifier codes can be representative of a transmission time from the stationary apparatus 200 for the particular acoustic signal. For example, the identifier code may represent a specific time, or the identifier code may be numbers or letters denoting the position (for example, first, second, nth) of each acoustic signal in a sequence of acoustic signals. The transmission time of each acoustic signal can then be correlated based on the numbers or letters. As will be appreciated, the use of numbers or letters as the identifier code can allow the bit-size of the identifier code to be relatively short. Furthermore, the controller 214 may associate and store the transmission time of each acoustic signal along with the identifier code for each.

During its travel through the pipeline, the mobile apparatus 2 measures, generally continuously, periodically and/or intermittently, the conditions of its surroundings using the sensor units described above. Since the mobile apparatus 2 is typically moving, the conditions are measured at progressively different locations inside the pipeline. The mobile apparatus 2 also receives the acoustic signals transmitted from the stationary apparatus 200 as it is moving inside the pipeline. For example, FIG. 14 shows the first acoustic signal w₁ reaching the mobile apparatus 2 at time t₂ after having propagated for some time through the pipeline.

In some examples, the controller 6 of the mobile apparatus 2 may be configured to control the sensors units to measure conditions each time an acoustic signal is received by the mobile apparatus 2 (from the stationary apparatus 200). Therefore, the measured conditions may represent the conditions surrounding the mobile apparatus 2 at the approximate time an acoustic signal is received. After measuring the one or more conditions, the controller 6 stores in the memory device 8 data pertaining to the conditions in association with the identifier code of the received acoustic signal at that given time. Therefore, when reading the stored data, retrieval of a particular identifier code of one acoustic signal can allow for retrieval of the conditions surrounding the mobile apparatus 2 at the time the acoustic signal is received.

The identifier code can allow for determination of the location of the mobile apparatus 2 inside the pipeline at the time the acoustic signal is received by the mobile apparatus 2. If the conditions measured by the mobile apparatus 2 are indicative of a leak, the location of the mobile apparatus 2 corresponds with the location of the leak. The identifier code associated with these conditions can be correlated to determine the location of the mobile apparatus 2 and therefore the location of the leak.

For example, in FIG. 14, the mobile apparatus 2 at time t₂ has reached the location of a leak in the pipeline. When conditions surrounding the mobile apparatus 2 are measured at time t₂, the leak will be detected, and the location of the mobile apparatus 2 will also be the location of the leak.

Although the identifier code may allow for determination of the location of the mobile apparatus 2, in some examples, the location may not be immediately calculated at the time each acoustic signal is received by the mobile apparatus 2. The locations corresponding to the received acoustic signals may be calculated after the mobile apparatus 2 has completed its travel through the pipeline. By not immediately calculating the current location of the mobile apparatus 2, a decrease in the processing performed by the controller 6 can be achieved, thereby reducing power consumption of the mobile apparatus 2.

The controller 6 of the mobile apparatus 2 may also be configured to control the sensor units to measure conditions surrounding the mobile apparatus 2 independently of receiving the acoustic signals from the stationary apparatus 200. For example, the controller 6 may control the sensor units to measure conditions more often than receiving the periodic acoustic signals. Accordingly, each measured condition can be stored with a time stamp representing the time at which the measured condition was taken. Similarly, the identifier code of each received acoustic signal can also be stored with a time stamp representing its reception time. It will be appreciated that although each measured condition may not be directly linked to an identifier code, the conditions and the identifier codes may still be associated via their respective time stamps. For example, where a measured condition has a time stamp falling between the time stamps of an identifier code of a first received acoustic signal and an identifier code of a second received acoustic signal, it can be determined that the location at which the measured condition was taken falls in between the locations at which the first and second acoustic signals were received. Although two examples of associating the conditions with the identifier codes of the received acoustic signals are presented herein, other examples are possible.

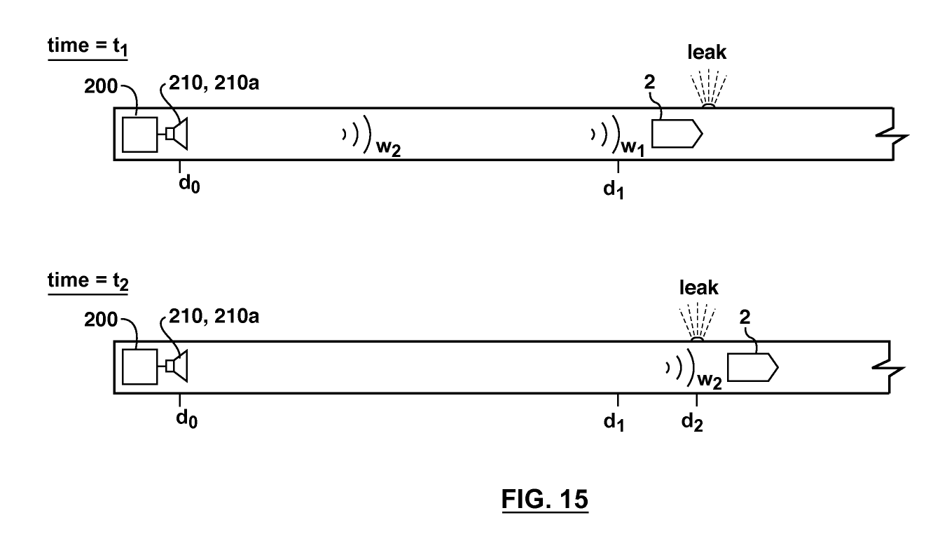

The controller 6 of the mobile apparatus 2 may be further configured to calculate, for each received acoustic signal, a velocity of the mobile apparatus 2 traveling through the pipeline. Referring to FIG. 15, acoustic signals w₁ and w₂ are periodically transmitted from the stationary apparatus 200 and are propagating through the pipeline towards the mobile apparatus 2. At time t₁, the acoustic signal w₁ is received by the mobile apparatus 2 at a first location d₁. Since each acoustic signal is transmitted periodically and travels through the pipeline at generally the same velocity, the acoustic signal w₂ that is transmitted one period p after the acoustic signal w₁ will be at a distance vₛp away from d₁, where vₛ is the velocity of the acoustic signal. At time t₂, the acoustic signal w₂ is received by the mobile apparatus 2 at a location d₂. In the time interval between t₁ and t₂, the mobile apparatus 2 will have traveled a distance equal to Δt*v_{MA}, where Δt=(t₂−t₁). Meanwhile, in the same time interval, the acoustic signal w₂ will have traveled a distance equal to Δt*vₛ=Δt*v_{MA}+vₛ*p. Therefore, the velocity of the mobile apparatus 2 at the time the acoustic signal w₂ is received by the mobile apparatus 2 may be estimated to be:

$${v}_{MA} = {v}_{s} \frac{( Δ t - p )}{Δ t} .$$

In this case, the velocity of the mobile apparatus 2 at the time the second acoustic signal w₂ is received is calculated based on a velocity of the acoustic signal in the pipeline, the reception time of a previously received acoustic signal, the reception time of a currently received acoustic signal, and the period in which each acoustic signal is transmitted by the stationary apparatus 200. Furthermore, where the mobile apparatus 2 comprises a phase meter unit 76 (FIG. 5), the velocity of the acoustic signal in the pipeline may further be adjusted based on changes in phase of the material inside the pipeline.

Alternatively or additionally, the controller 6 may be configured to calculate the current location of the mobile apparatus 2 inside the pipeline. For example, referring again to FIG. 15, the location of the mobile apparatus 2 at time t₂ can be calculated according to:

d₂=d₁+ν_{MA}Δt.

In this case, the location of the mobile apparatus 2 at the time the second acoustic signal w₂ is received is calculated based on a velocity of the acoustic signal in the pipeline, the reception time of a previously received acoustic signal, the reception time of a currently received acoustic signal, the period in which each acoustic signal is transmitted by the stationary apparatus 200, and the location of the mobile apparatus 2 at the time the previously received acoustic signal was received. Furthermore, the location of the mobile apparatus 2 at the time the previously received acoustic signal is received can be initialized to be zero upon start up. This value can then updated for each subsequently received acoustic signal.

Where the velocity and/or location of the mobile apparatus 2 is calculated by the controller 6, the controller 6 may further store data pertaining to the velocity and/or location of the mobile apparatus 2, such that the measured conditions, the identifier codes, and the calculated velocity and/or location of the mobile apparatus 2 can all be associated and stored.

Furthermore, where the mobile apparatus 2 comprises the emergency transmitter unit 124 (FIG. 1), the mobile apparatus 2 can determine if the mobile apparatus 2 is stationary, and decide whether or not to turn on the emergency transmitter unit 124 to send an emergency signal. Determination of whether the mobile apparatus 2 is stationary may be made based on the calculated velocity of the mobile apparatus 2 for each received acoustic signal. Alternatively, this determination may be made by comparing the difference between the reception time of the currently received acoustic signal and the reception time of a previously received acoustic signal, and comparing this difference with the period in which each acoustic signal is transmitted by the stationary apparatus 200. If this difference is approximately the same as the period, then the mobile apparatus 2 may be determined to be stationary. If the mobile apparatus 2 is determined to be stationary, then controller 6 may turn on the emergency transmitter unit 124 to begin transmission of emergency signals. Where the controller 6 does not calculate a location of the mobile apparatus 2, the emergency signal may contain only an indication that the mobile apparatus 2 is stationary and the identifier code of the currently received acoustic signal. Where the controller 6 is configured to calculate the location of the mobile apparatus 2, this information may further be included in the emergency signal.

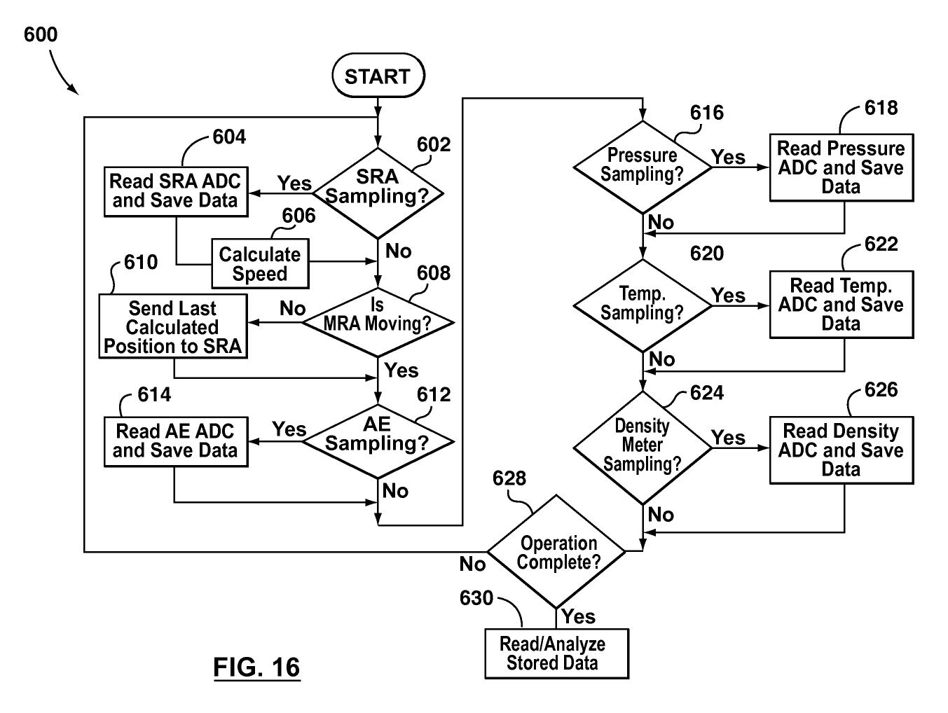

Referring now to FIG. 16, illustrated therein is a method 600 for controlling the mobile apparatus 2 traveling through a pipeline, and used in combination with the stationary apparatus 200 to detect leaks in the pipeline. The method 600 can be implemented by the controller 6. Accordingly, the following description may be abbreviated for clarity; further details of the method 600 are provided above with reference to the controller 6 and the other components of the mobile apparatus 2 described above.

At step 602, the acoustic signal receiver unit 104 is checked to determine whether an acoustic signal has been received by the mobile apparatus 2. If an acoustic signal has been received, the identifier code contained in the received acoustic signal is stored at step 604. If an acoustic signal has been received, and where the controller 6 is configured accordingly, a velocity and/or location of the mobile apparatus 2 may also be calculated at step 606. Furthermore, the identifier code of the acoustic signal is stored along with the calculated velocity and/or location, if applicable. After step 606, or if no acoustic signal is received, the method proceeds to step 608.

At step 608, whether the mobile apparatus 2 is stationary is determined. If the mobile apparatus is stationary, the emergency transmitter unit 124 is turned on to send an emergency signal at step 610. If the mobile apparatus 2 is not stationary, the method proceeds to 612.

At step 612, it is determined whether the presence of acoustic vibrations should be sensed using the AE sensor unit 42. If acoustic vibrations should be sensed, the data generated by the AE sensor unit 42 is read and stored at step 614. After step 614, or if the presence of acoustic vibrations should not be sensed, the method proceeds to step 616.

At step 616, it is determined whether the pressure should be measured using the pressure sensor unit 10. If pressure should be measured, the data generated by the pressure sensor unit 10 is read and stored at step 618. After step 618, or if the pressure should not be measured, the method proceeds to step 620.

At step 620, it is determined whether the temperature should be measured using the temperature sensor unit 26. If temperature should be measured, the data generated by the temperature sensor unit 26 is read and stored at step 622. After step 622, or if the temperature should not be measured, the method proceeds to step 624.

At step 624, it is determined whether the phase of the material inside the pipeline should be measured using the phase meter 76. If phase should be measured, the data generated by the phase meter 76 is read and stored at step 626, or if the phase of the material should not be measured, the method proceeds to step 628.

At step 628, it is determined whether the mobile apparatus 2 should continue its operation. This may refer to whether the mobile apparatus 2 is still inside the pipeline or whether has been extracted from the pipeline. If the mobile apparatus 2 is to continue operating, the method returns to step 602. If the mobile apparatus 2 has terminated its travel though the pipeline, the data stored by the mobile apparatus 2 is read and analyzed at step 630.

Of course, variation of the steps of the method 600 are possible. For example, steps 612, 616, 620, 624 may be performed generally in any order. Furthermore, the measurement of any one of the conditions may be repeated more than once in every iteration of the method 600.

During the operation of the mobile apparatus 2 and the stationary apparatus 200 in combination to detect leaks within a pipeline, the stationary apparatus 200 may receive reflected acoustic signals, wherein each reflected acoustic signal can correspond to an acoustic signal originally transmitted from the stationary apparatus 200 and reflected off of an obstacle in the pipeline. In some cases, the acoustic signal can reflect off of the mobile apparatus 2. Referring back to FIG. 14, a first reflected signal rw₁ is shown being reflected off of the mobile apparatus 2 at time t₂, and traveling in a direction opposite to the direction of travel of the first signal w₁. At time t₃, the first reflected signal rw₁ reaches back to the stationary apparatus 200, where it can be received by the acoustic signal receiver 222 and read by the controller 214, described above.

The controller 214 may be configured to, for each received reflected acoustic signal, calculate an obstacle reflection location, corresponding to the location of the obstacle when the acoustic signal was reflected off of the obstacle to generate the reflected acoustic signal. Assuming that a velocity of an acoustic signal is the same when traveling away from the stationary apparatus 200 as when traveling towards it, the obstacle reflection location may be calculated according to:

$${d}_{leak} = ( \frac{{t}_{3} - {t}_{1}}{2} ) {v}_{s} ;$$

wherein t₁ is the transmission time of the acoustic signal, t₃ is the reception time of the reflected acoustic signal, and vₛ is the velocity of the acoustic signal. As it will be appreciated, calculation of the obstacle reflection location can be based on at least these three parameters, although the velocity of the acoustic signal may be adjusted according to variances in acoustic signal traveling velocities with the flow of material in the pipeline and against the flow. Since the reflected acoustic signal also may present the same identifier code as the original acoustic signal, the transmission time of the original acoustic signal may be retrieved. After calculating the obstacle location in the pipeline, the controller 214 of the stationary apparatus 200 can store the calculated location and the identifier code such that the calculated location is associated with the identifier code.

After the mobile apparatus 2 has completed its travel through the pipeline, the mobile apparatus 2 can be extracted from the pipeline so that data stored during its travel can be read and analyzed. Similarly, data stored by the stationary apparatus 200 can be read and analyzed, and cross-referenced with the data of the mobile apparatus 2. Where the mobile apparatus 2 is configured such that measured conditions are associated with identifier codes of received acoustic signals, but the location of the mobile apparatus 2 is not calculated, the data of the stationary apparatus 200 can be used to determine the location of the mobile apparatus 2 for each received acoustic signal. Each identifier code stored by the mobile apparatus 2 can be matched to the same identifier code stored by the stationary apparatus 200. The identifier codes stored by the stationary apparatus 200 can be associated with the obstacle reflection location; the identifier codes stored by the mobile apparatus 2 can be associated with the measured conditions. Therefore, the identifier codes can be matched as between the stationary apparatus 200 and the mobile apparatus 2 to correlate an obstacle reflection location with the measured conditions for each acoustic signal, enabling the location of a leak to be identified.

In examples where the mobile apparatus 2 is configured to calculate a current location of the mobile apparatus 2, cross-referencing the mobile apparatus 2 stored data with the stationary apparatus stored data may be useful to verify the locations of the mobile apparatus 2 calculated by each apparatus. For example, current locations calculated by the mobile apparatus 2 may be inaccurate due to fluctuations in velocity of the mobile apparatus 2 between receptions of acoustic signals. By cross-referencing the stored data of the mobile apparatus 2 and the stationary apparatus 200, the locations calculated by the mobile apparatus 2 may be verified and corrected if necessary.

Similarly, the location of the obstacle calculated by the stationary apparatus 200 may be inaccurate due to phase changes in the material in the pipeline. For example, changes in phase of the material may affect the velocity of acoustic signals propagating through the pipeline. Since measurements of the phase made by the phase meter 76 may not be communicated to the stationary apparatus 200 while the mobile apparatus 2 is traveling through the pipeline, calculations of the reflected obstacle location at the stationary apparatus 200 do not take into account changes in the phase of the material in the pipeline. However, by cross-referencing the stored data of the mobile apparatus 2 and the stationary apparatus 200, the measurements of the phase taken by the mobile apparatus 2 may be used to adjust the acoustic signal velocity used to calculate the location of the obstacle.

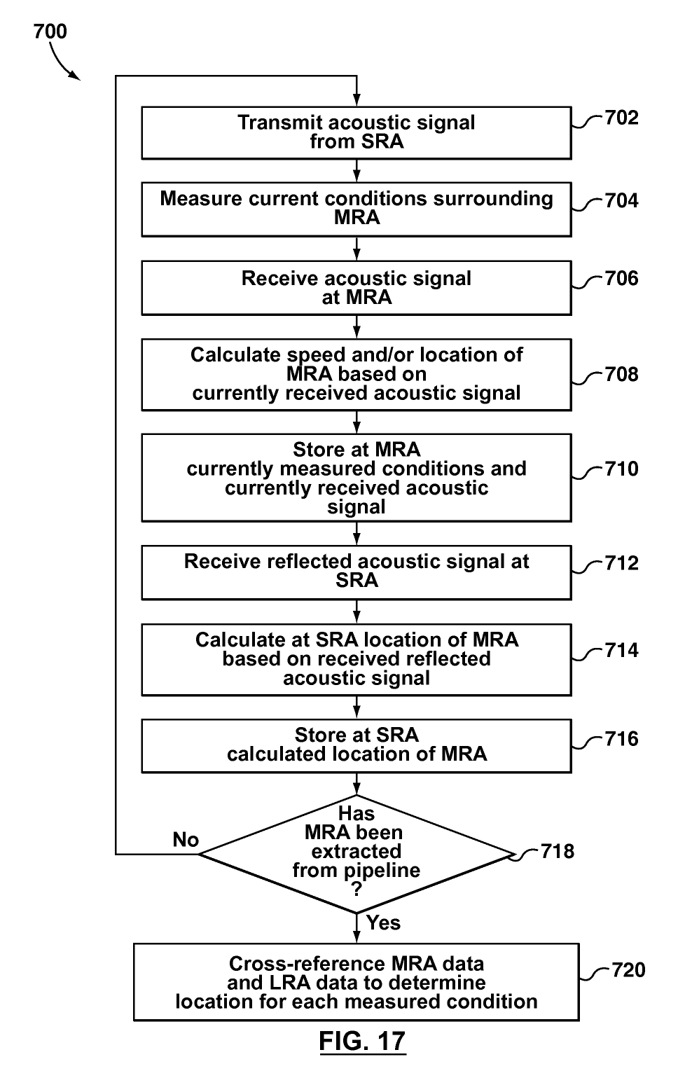

Referring now to FIG. 17, illustrated therein is a method 700 for controlling the mobile apparatus 2 and stationary apparatus 200 to detect leaks in a pipeline. The method 700 can be implemented by the controller 6 and the controller 214. Accordingly, the following description may be abbreviated for clarity; further details of the method 700 are provided above with reference to the controller 6 and the controller 214 and the other components of the mobile apparatus 2 and the stationary apparatus 200.

At step 702, an acoustic signal is transmitted from the stationary apparatus 200 into the pipeline in the direction of the mobile apparatus 2 that is traveling through the pipeline.

At step 704, one or more conditions surrounding the mobile apparatus 2 are measured.

At step 706, the mobile apparatus 2 receives the acoustic signal transmitted from the stationary apparatus 200. It will be appreciated that the order of steps 704 and 706 are interchangeable.

At step 708, where the mobile apparatus 2 is configured accordingly, the velocity and/or location of the mobile apparatus 2 may optionally be calculated.

At step 710, the conditions measured at step 704 and the identifier code of the received acoustic signal are stored by the mobile apparatus 2, wherein the measured conditions are associated with the identifier code. It will be appreciated that steps 704 to 710 can be further represented in more detail using an iteration of the method 600, comprising steps 602 to 628.

At step 712, the reflected acoustic signal, corresponding to the transmitted acoustic signal reflected off of the mobile apparatus 2, is received at the stationary apparatus 200.

At step 714, a location of the obstacle is calculated based on the received reflected acoustic signal.

At step 716, the calculated location of the obstacle and the identifier code of the reflected acoustic signal are stored at the stationary apparatus 200 such that the calculated location of the obstacle is associated with the identifier code.

At step 718, both the mobile apparatus 2 and the stationary apparatus 200 determine whether the mobile apparatus 2 has ended its travel through the pipeline to indicate that detection operation should be terminated. Where the mobile apparatus 2 has not terminated its travel, the method returns to step 702 to begin another iteration. If the mobile apparatus 2 has terminated, the method 700 proceeds to step 720.

At step 720, stored data of the mobile apparatus 2 and the stationary apparatus 200 are cross-referenced, either to determine the location of each condition measured by the mobile apparatus 2, or to verify and adjust the stored data.

It should be appreciated that the stationary apparatus 200 can be used without the mobile apparatus 2, to detect obstacles in a pipeline that cause acoustic signals transmitted from the stationary apparatus 200 to be reflected back. As a first example, changes in diameter of the pipeline or other anomalies in the pipeline may cause the acoustic signals to be reflected. As a second example, clogs or excess deposits in the pipeline may also cause the acoustic signals to be reflected. As a third example, the stationary apparatus 200 may be used during a pigging operation to monitor the location of the PIG inside the pipeline and to detect if the PIG has become stuck. As a fourth example, the stationary apparatus 200 may be used to detect the presence of slugs in the pipeline; slugs are buildup of liquid or gas inside the pipeline that may cause damage to terminal facilities of the pipeline. In this fourth example, the stationary apparatus 200 may be permanently installed at the pipeline terminal to detect incoming slugs.

As described above, the stationary apparatus 200 can transmit a high power, low frequency acoustic signal into the pipeline. When used without the mobile apparatus 2, the acoustic signals transmitted from the stationary apparatus 200 may not require an identifier code. However, an identifier code may be used to confirm correspondence between a reflected acoustic signal and the original transmitted acoustic signal.

A reflected acoustic signal being received by the acoustic signal receiver 222 would indicate the presence of an obstacle in the pipeline. The controller 214 can then calculate the obstacle reflection location based on the transmission time of the acoustic signal, the reception time of the reflected acoustic signal, and the velocity of the acoustic signal in the pipeline. Not receiving a reflected acoustic signal after some time may indicate that there is no obstacle in the pipeline. This time may correspond to the time that the acoustic signal will propagate before it attenuates below a specific threshold.

A single acoustic signal may be sufficient for the first and second example where the stationary apparatus 200 is only used to detect the presence of pipeline diameter changes or the presence of clogs or excess deposits. However, in the third and fourth examples, where the presence and location of an obstacle in the pipeline is to be monitored, the stationary apparatus 200 can periodically transmit acoustic signals to locate the PIG or monitor for the presence of slugs. Therefore, after receiving a reflected acoustic signal, or determining that no obstacle is present in the pipeline, the stationary apparatus 200 can transmit another acoustic signal to continue monitoring the pipeline.

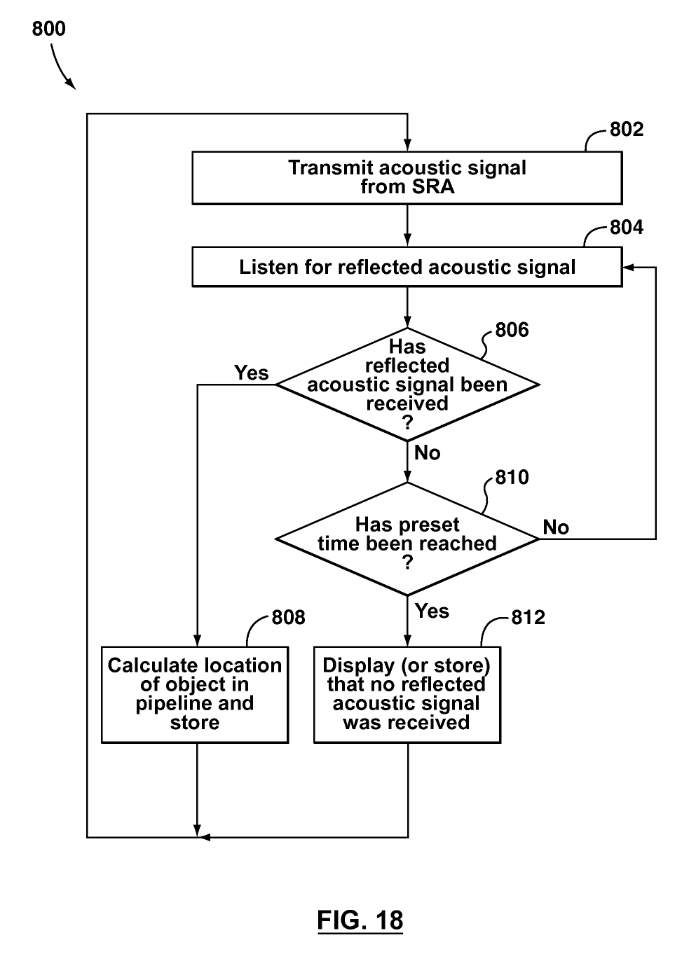

Referring now to FIG. 18, illustrated therein is a method 800 for controlling the stationary apparatus 200 to monitor a pipeline, which may be suitable for monitoring for presence of slugs inside the pipeline. The method 800 can be implemented using the controller 214. Accordingly, the following description may be abbreviated for clarity; further details of the method 800 are provided above with reference to the controller 214 and the other components of the stationary apparatus 200.

At step 802, the stationary apparatus 200 transmits an acoustic signal into the pipeline.

At step 804, the stationary apparatus 200 listens for a reflected acoustic signal corresponding to the transmitted acoustic signal reflecting off of an obstacle inside the pipeline.

At step 806, if a reflected acoustic signal is received, the method 800 proceeds to step 808 to calculate the obstacle reflection location. If a reflected acoustic signal is not received, the method proceeds to step 810.

At step 810, it is determined if a time threshold has been reached, the threshold corresponding to the maximum time of propagation of the acoustic signal before its amplitude drops below an amplitude threshold due to attenuation. If the time threshold has not been reached, the method returns to step 804 to continue to listen for the reflected acoustic signal. If the time threshold has been reached, indicating that no obstacle is present in the pipeline, the method proceeds to step 812.

At step 812, a signal is sent indicating that an obstacle is present in the pipeline. The method 800 then proceeds to step 802 to send another acoustic signal.

While the above description provides examples of one or more apparatuses or methods, it will be appreciated that other apparatuses or methods may be within the scope of the accompanying claims.

I claim:

1. In combination:
a) a stationary apparatus for connection to a pipeline, comprising
i) an acoustic signal transmitter configured to transmit acoustic signals periodically into the pipeline, and
ii) a controller coupled to the acoustic signal transmitter; and
b) a mobile apparatus for insertion into the pipeline, comprising
i) at least one sensor unit configured to measure conditions surrounding the mobile apparatus as the mobile apparatus travels inside the pipeline,
ii) an acoustic signal receiver unit configured to receive the acoustic signals from the stationary apparatus,
iii) a memory device, and
iv) a controller coupled to the at least one sensor unit, the acoustic signal receiver unit, and the memory device, and configured to associate the acoustic signals with the conditions being measured by the at least one sensor unit based on a reception time of the acoustic signal and the conditions being measured generally at the reception time, and store data in the memory device pertaining to the acoustic signals and the conditions.

2. The combination of claim 1, wherein each of the acoustic signals transmitted comprises an identifier code that is representative of a transmission time of the respective acoustic signal at the stationary apparatus, and the controller of the mobile apparatus is configured to associate the identifier code of each of the acoustic signals with the conditions being measured by the mobile apparatus.

3. The combination of claim 2, wherein the stationary apparatus further comprises:
a) an acoustic signal receiver unit coupled to the controller, and configured to receive reflected acoustic signals inside the pipeline; and
b) a memory device coupled to the controller, the controller configured to store data in the memory device pertaining to the reflected acoustic signals.

4. The combination of claim 3, wherein the controller of the stationary apparatus is configured to calculate a location of the mobile apparatus relative to the stationary apparatus based on a transmission time of one of the acoustic signals, a reception time of the corresponding reflected acoustic signal, and a velocity of the acoustic signals inside the pipeline.

5. The combination of claim 1, wherein the at least one sensor unit of the mobile apparatus comprises at least one of a pressure sensor unit, a temperature sensor unit, and an acoustic emissions sensor unit.

6. The combination of claim 5, wherein the mobile apparatus further comprises a phase meter coupled to the controller of the mobile apparatus, the phase meter configured to detect the phase of a fluid inside the pipeline.

7. The combination of claim 1, wherein the mobile apparatus further comprises an emergency transmitter unit coupled to the controller of the mobile apparatus, the emergency transmitter unit configured to transmit an emergency signal into the pipeline.

8. The combination of claim 7, wherein the controller of the mobile apparatus is further configured to:
a) determine whether the mobile apparatus is moving based on a reception time of a currently received acoustic signal, a reception time of a previously received acoustic signal, and a period of the acoustic signals; and
b) if the mobile apparatus is not moving, transmit an emergency signal from the emergency transmitter unit.

9. A method of detecting a leak in a pipeline, comprising:
providing a stationary apparatus, and connecting the stationary apparatus to the pipeline;
transmitting acoustic signals periodically from the stationary apparatus into the pipeline;
providing a mobile apparatus, and inserting the mobile apparatus into the pipeline such that the mobile apparatus travels inside the pipeline;
measuring conditions surrounding the mobile apparatus as the mobile apparatus travels inside the pipeline, the conditions indicating the presence of the leak when the mobile apparatus is in the vicinity of the leak;
receiving at the mobile apparatus the acoustic signals transmitted from the stationary apparatus; and
associating each of the acoustic signals received at the mobile apparatus with the conditions being measured by the mobile apparatus based on a reception time of the acoustic signal and the conditions being measured generally at the reception time.

10. The method of claim 9, wherein the step of transmitting comprises encoding in each of the acoustic signals an identifier code that is representative of a transmission time of the respective acoustic signal from the stationary apparatus, and the step of associating comprises associating the identifier code of each of the acoustic signals with the conditions being measured by the mobile apparatus.

11. The method of claim 10, further comprising receiving at the stationary apparatus reflected acoustic signals.

12. The method of claim 11, further comprising calculating a location of the mobile apparatus relative to the stationary apparatus based on a transmission time of one of the acoustic signals from the stationary apparatus, a reception time of the corresponding reflected acoustic signal at the stationary apparatus, and a velocity of the acoustic signals inside the pipeline.

13. The method of claim 12, further comprising determining a location of the leak by correlating the particular identifier code associated with the conditions indicating the presence of the leak with a particular location of the mobile apparatus calculated generally at the transmission time corresponding to the particular identifier code.

14. The method of claim 13, further comprising:
storing at the mobile apparatus data pertaining to identifier codes and the conditions; and
storing at the stationary apparatus data pertaining to the locations of the mobile apparatus.

15. The method of claim 14, further comprising cross-referencing the data stored at the mobile apparatus with the data stored at the stationary apparatus.

16. The method of claim 9, wherein the conditions comprise at least one of temperature, pressure and amplitude of acoustic emissions.

17. The method of claim 16, wherein the step of measuring further comprises detecting the phase of a fluid inside the pipeline.

18. The method of claim 9, further comprising, for at least one of the acoustic signals received at the mobile apparatus, determining whether the mobile apparatus is moving based on a reception time of a currently received acoustic signal, a reception time of a previously received acoustic signal, and a period of the acoustic signals.

19. The method of claim 18, further comprising, if the mobile apparatus is not moving, transmitting an emergency signal from the mobile apparatus.

20. The method of claim 9, further comprising, for at least one of the acoustic signals received at the mobile apparatus, calculating a current location of the mobile apparatus relative to the stationary apparatus based on a reception time of a currently received acoustic signal, a reception time of a previously received acoustic signal, a previous location of the mobile apparatus when the previously received acoustic signal was received, a period of the acoustic signals, and a velocity of the acoustic signals inside the pipeline.

21. The method of claim 9, further comprising, for at least one of the acoustic signals received at the mobile apparatus, calculating a current velocity of the mobile apparatus based on a reception time of a currently received acoustic signal, a reception time of a previously received acoustic signal, a period of the acoustic signals, and a velocity of the acoustic signals inside the pipeline.

22. A mobile apparatus for insertion into a pipeline, comprising:
a) at least one sensor unit configured to measure conditions surrounding the mobile apparatus as the mobile apparatus travels inside the pipeline;
b) an acoustic signal receiver unit configured to receive acoustic signals that are transmitted periodically inside the pipeline, wherein the acoustic signals have a predetermined period;
c) a memory device; and
d) a controller coupled to the at least one sensor unit, the acoustic signal receiver unit, and the memory device, and configured to
i) calculate a current location of the mobile apparatus based on a reception time of a currently received acoustic signal, a reception time of a previously received acoustic signal, a previous location of the mobile apparatus when the previously received acoustic signal was received, the period of the acoustic signals, and a velocity of the acoustic signals inside the pipeline,
ii) associate the current location with the conditions being measured by the at least one sensor unit, and
iii) store data in the memory device pertaining to the location and the conditions.

23. The apparatus of claim 22, wherein the at least one sensor unit comprises at least one of a pressure sensor unit, a temperature sensor unit, and an acoustic emissions sensor unit.

24. The apparatus of claim 23, further comprising a phase meter coupled to the controller, and configured to detect the phase of a fluid inside the pipeline.

25. The apparatus of claim 22, further comprising an emergency transmitter unit coupled to the controller, and configured to transmit an emergency signal into the pipeline.

26. The apparatus of claim 25, wherein the controller is further configured to:
a) determine whether the mobile apparatus is moving based on the reception time of the currently received acoustic signal, the reception time of the previously received acoustic signal, and the period of the acoustic signals; and
b) if the mobile apparatus is not moving, transmit an emergency signal from the emergency transmitter unit.

27. A method of detecting a leak in a pipeline, comprising:
providing a mobile apparatus, and inserting the mobile apparatus into the pipeline such that the mobile apparatus travels inside the pipeline;
measuring conditions surrounding the mobile apparatus as the mobile apparatus travels inside the pipeline, the conditions indicating the presence of the leak when the mobile apparatus is in the vicinity of the leak;
receiving at the mobile apparatus acoustic signals that are transmitted periodically inside the pipeline, wherein the acoustic signals have a predetermined period;
calculating a current location of the mobile apparatus based on a reception time of a currently received acoustic signal, a reception time of a previously received acoustic signal, a previous location of the mobile apparatus when the previously received acoustic signal was received, the period of the acoustic signals, and a velocity of the acoustic signals inside the pipeline; and
associating the current location with the conditions being measured by the at least one sensor unit.

28. The method of claim 27, further comprising storing at the mobile apparatus data pertaining to the location and the conditions.

29. The method of claim 27, wherein the step of measuring comprises measuring at least one of temperature, pressure and amplitude of acoustic emissions.

30. The method of claim 28, wherein the step of measuring further comprises detecting the phase of a fluid inside the pipeline.

31. The method of claim 27, further comprising:
determining whether the mobile apparatus is moving based on the reception time of the currently received acoustic signal, the reception time of the previously received acoustic signal, and the period of the acoustic signals; and
if the mobile apparatus is not moving, transmitting an emergency signal from the mobile apparatus.

32. A stationary apparatus for connection to a pipeline, comprising:
a) an acoustic signal transmitter configured to transmit acoustic signals into the pipeline;
b) an acoustic signal receiver unit, configured to receive reflected acoustic signals inside the pipeline;
c) a memory device; and
d) a controller coupled to the acoustic signal transmitter, the acoustic signal receiver unit, and the memory device, and configured to
i) encode an identifier code in each of the acoustic signals that is representative of a transmission time of the respective acoustic signal, and
ii) store data in the memory device pertaining to the reflected acoustic signals and the identifier codes.

33. The apparatus of claim 32, wherein the controller is configured to link the acoustic signals with the reflected acoustic signals based on the identifier codes present in the reflected acoustic signals.

34. The apparatus of claim 33, wherein the controller is configured to calculate a location of an obstacle relative to the stationary apparatus based on the transmission time of one of the acoustic signals, a reception time of the corresponding reflected acoustic signal, and a velocity of the acoustic signals inside the pipeline.

35. The apparatus of claim 34, wherein the memory device is configured store data pertaining to the location of the obstacle.

36. The apparatus of claim 32, wherein the acoustic signal transmitter comprises:
a) an outer casing that is connectable to the pipeline;
b) a sealing plug disposed in the outer casing;
c) a vibrating diaphragm disposed in the outer casing, and spaced apart from the sealing plug, defining a first chamber therebetween;
d) a transducer disposed in the first chamber and coupled to the controller, the transducer configured to emit acoustic signals that propagate through the first chamber and cause the vibrating diaphragm to vibrate, thereby generating acoustic signals that propagate into the pipeline.

37. The apparatus of claim 36, further comprising a variable weight coupled to the vibrating diaphragm.

38. The apparatus of claim 36, wherein the acoustic signal receiver unit comprises an acoustic signal receiver positioned in the first chamber.

39. The apparatus of claim 36, further comprising a pressure injection mechanism coupled to the first chamber.

40. The apparatus of claim 39, wherein the pressure injection mechanism comprises a first pressure tube connected to the first chamber, a first pressurized fluid feed, and a first injection valve coupling the first pressure tube and the first pressurized fluid to selectively pass a pressurized first fluid to the first chamber.

41. The apparatus of claim 40, further comprising a pipeline valve spaced apart from the vibrating diaphragm, defining a second chamber therebetween, the acoustic signals propagating from the vibrating diaphragm through the second chamber into the pipeline.

42. The apparatus of claim 41, wherein the pressure injection mechanism further comprises a second pressure tube connected to the second chamber, a second pressurized fluid feed, and a second injection valve coupling the second pressure tube and the second pressurized fluid to selectively pass a pressurized second fluid to the second chamber, the second fluid being different than the first fluid.

43. The apparatus of claim 32, wherein the acoustic signal transmitter comprises:
a) an outer casing that is connectable to the pipeline;
b) a piston disposed in the outer casing;
c) a motor;
d) a shaft driven by the motor; and
e) a coupling rod connecting the shaft to the piston, wherein rotary motion of the shaft causes reciprocating motion of the coupling rod and the piston, and the reciprocating motion of the piston generates acoustic signals that propagate into the pipeline.

44. The apparatus of claim 43, wherein the motor is coupled to the controller, and the controller is configured to command torque of the motor to vary frequency and amplitude of the acoustic signals propagating into the pipeline.

45. The apparatus of claim 43, further comprising a pressure injection mechanism for injecting pressurized fluid into a piston chamber defined by the outer casing, the piston and a chamber end wall.

46. The apparatus of claim 43, further comprising at least one mechanical spring disposed in a piston chamber defined by the outer casing, the piston and a chamber end wall, the at least one mechanical spring configured to exert force on the piston.

47. The apparatus of claim 43, further comprising at least one high pressure hose coupling the outer casing to the pipeline, the acoustic signals generated by the piston travel through the high pressure hose to propagate into the pipeline.

48. A method of detecting an obstacle in a pipeline, comprising:
providing a stationary apparatus, and connecting the stationary apparatus to the pipeline;
transmitting acoustic signals from the stationary apparatus into the pipeline, wherein each of the acoustic signals comprises an identifier code that is representative of a transmission time of the respective acoustic signal;
receiving at the stationary apparatus a plurality of reflected acoustic signals;
linking the acoustic signals with the reflected acoustic signals based on the identifier codes present in the reflected acoustic signal; and
calculating a location of the obstacle relative to the stationary apparatus based on the transmission time of the acoustic signal, a reception time of the reflected acoustic signal, and a velocity of the acoustic signals inside the pipeline.
